(19) United States
(12) Patent Application Publication
(10) Pub. No.: US 2026/0096640 A1
(43) Pub. Date: Apr. 9, 2026

(54) LUGGAGE LOCK

(71) Applicant: ABUS AUGUST BREMICKER SÖHNE KG, Wetter-Volmarstein (DE)

(72) Inventor: Bernhard GARTHE, Gevelsberg (DE)

(21) Appl. No.: 19/115,568

(22) PCT Filed: Sep. 18, 2023
(86) PCT No.: PCT/EP2023/075584

§ 371 Date: Mar. 26, 2025

(30) Foreign Application Priority Data
Sep. 27, 2022 (DE) 10 2022 124 866.6

(51) Int. Cl. A45C 13/18; G07C 9/00

(52) U.S. Cl. CPC A45C 13/18; G07C 9/00309; G07C 9/00896

(57) ABSTRACT

An electronic luggage lock for securing a piece of luggage that can be opened by a security institution without destruction includes an electromechanical locking mechanism by which a securing section of the piece of luggage can be selectively locked or released relative to the luggage lock, a control device, and an identification device that provides a wirelessly readable lock identification code. The control device is connected to a code receiving device that is configured to receive an opening code via a wireless connection, the control device is configured to compare the received opening code with a stored release code and to control the electromechanical locking mechanism to release the securing section if the received opening code matches the stored release code.

### CROSS-REFERENCE TO RELATED APPLICATIONS

The present application is the National Phase entry of International Patent Application No. PCT/EP2023/075584 filed Sep. 18, 2023, which claims priority to German Patent Application 10 2022 124 866.6 filed Sep. 27, 2022.

### TECHNICAL FIELD

The present disclosure relates to a luggage lock for securing a piece of luggage that may be opened by a security institution without destruction.

The present disclosure further relates to a piece of luggage comprising such a luggage lock and to a method of providing an opening code for a security institution for opening a luggage lock and a method of opening a luggage lock by a security institution.

### BACKGROUND

A luggage lock may in particular be provided to secure a piece of luggage against unauthorized access and to secure objects taken along in the piece of luggage against theft while the piece of luggage is unattended. In addition to protection against theft, a securing of pieces of luggage by their owners may, however, also be provided to prevent prohibited items, such as drugs, from being packed into the piece of luggage by third parties for smuggling in an unobserved moment, and in particular also after the luggage has been checked in, in order to remove these items from the piece of luggage again at a stopover or the destination airport before or after the piece of luggage is returned to its owner. Such a process in particular entails the risk for the owner of the piece of luggage that, if the removal fails, the owner will be confronted with the accusation that he or she had already originally carried the respective items with him or her.

While luggage locks may thus initially serve to secure a piece of luggage against unauthorized access, there is furthermore a high demand, in particular for air travel, to guarantee security during the journey, wherein dangerous substances such as explosives in particular have to be prevented from getting on board an aircraft with the checked-in luggage. This may require luggage that has already been checked in to be checked and opened by a security institution without the luggage owner or passenger being present, wherein such checks may also take place at any stopovers, for example. In addition to such security checks, an opening of pieces of luggage may also be required to detect a possible smuggling of drugs or other items in a passenger's luggage. In the present context, a security institution may in particular be understood as an authority or a security service provider, in particular a state-authorized security service provider.

Therefore, in connection with the securing of pieces of luggage, there is generally the problem that, on the one hand, the pieces of luggage have to be reliably secured against unauthorized access by appropriate luggage locks, but, on the other hand, the security institutions have to be offered a possibility of opening the piece of luggage for a check without having to destroy the luggage lock for this purpose.

This problem has so far been countered for example in the USA by using a lock cylinder in luggage locks for securing pieces of luggage, which lock cylinder may be opened by a respective special key that is available to the employees of the security institutions. Thus, by purchasing a luggage lock or a piece of luggage having a luggage lock that has been certified by the US Transportation Security Administration (TSA) and may therefore be referred to as a TSA lock, the owner may, on the one hand, secure the piece of luggage, but, on the other hand, may ensure that the U.S. security institutions have an associated special key and will open the piece of luggage non-destructively in the event of a check. Luggage locks that enable a non-destructive opening by the security institutions based on this concept or TSA locks are, for example, known from US 8 875 552 B2, WO 2021/129942 A1, US 2019/0055753 A1 and US 2017/0073999 A1.

However, to enable a quick check of pieces of luggage, the existing concept requires a limitation to a relatively small number of currently eight different special keys so that an employee of the security institution may quickly find the special key provided for opening a luggage lock and does not have to select it from a large number of different keys. In this regard, each TSA lock may be opened by a respective one of the eight different special keys, wherein it is also necessary that information about the respective associated special key is clearly visibly applied to the luggage locks so that an employee of the security institution may immediately select the required special key and does not have to try out different special keys.

However, this small number of special keys compromises the security against manipulation of luggage locks to be opened without destruction since a replica of one or more of these special keys also enables unauthorized persons to access the secured pieces of luggage. The requirement for clearly visible information about the special key required may also make it easier for unauthorized persons to gain access since these persons likewise do not have to try out different special keys, but can immediately select the correct key and open the piece of luggage. However, such a procedure has to create the impression on uninvolved persons in the vicinity of the piece of luggage that the authorized owner opens the luggage lock with an associated key so that a theft of items from the piece of luggage or an adding of contraband items may take place inconspicuously after a replica of a respective special key. Furthermore, it only possible with difficulty for the owner of a piece of luggage into which such contraband items and/or drugs have been subsequently introduced, in particular in view of the securing of the piece of luggage by an unbroken luggage lock, to exonerate himself/herself from the suspicion of already directly carrying such items. In such a case, however, a high effort also arises for the security institutions by prosecuting ultimately innocent persons, which also ties up capacities for prosecuting the persons who actually introduced the items into the piece of luggage.

It is therefore an object of the present disclosure to provide a luggage lock that provides reliable protection of a piece of luggage against access by unauthorized persons, but that may at the same time be opened by authorized employees of a security institution without destruction.

### SUMMARY

This object is satisfied by a luggage lock having the features of the present disclosure.

This luggage lock is an electronic luggage lock for securing a piece of luggage that may be opened without destruction by a security institution. The electronic luggage lock comprises an electromechanical locking mechanism by which a securing section of the piece of luggage may be selectively locked or released relative to the luggage lock, a control device for controlling the electromechanical locking mechanism, and an identification device. The identification device provides a lock identification code that is individually associated with the luggage lock and that may be wirelessly read by a mobile opening device, in particular a smartphone. The control device is connected to a memory in which a release code associated with the lock identification code is stored. Furthermore, the control device is connected to a code receiving device that is configured to receive an opening code from the mobile opening device, in particular a smartphone, via a wireless connection, wherein the control device is configured to compare the received opening code with the stored release code and to control the electromechanical locking mechanism to release the securing section if the received opening code matches the stored release code.

Since the luggage lock has an identification device that provides a lock identification code, the luggage lock may be individually and uniquely identified. Furthermore, the design of the luggage lock as an electronic luggage lock makes it possible to open the luggage lock by transmitting the opening code so that a non-destructive opening of the luggage lock may generally be made possible for a plurality of persons if these persons are provided with the opening code.

To enable a security institution or its employees to open the luggage lock without destruction, an owner of the luggage lock may therefore, for example before the start of a journey, store the opening code together with the lock identification code in a database that may be read by the security institution, wherein the opening code may in particular be stored in encrypted form in the database. An employee of the security institution may then, in the event of a check, identify the lock by reading the identification device and may transmit the lock identification code to the database to request the associated opening code. This reading of the identification device and requesting of the opening code may in particular take place by the opening device, in particular a smartphone, by which the opening code is ultimately also transmitted to the code receiving device for opening the luggage lock. If the opening code is stored, the opening code may be read from the database by the employee of the security institution or the opening code may be transmitted to the employee or his/her opening device, whereupon the employee may open the electronic luggage lock non-destructively by transmitting the opening code to the code receiving device.

Furthermore, provision may be made that a data pair of the lock identification code and the opening code is already transmitted to the database of the security institution by the manufacturer of the luggage lock or the manufacturer of a piece of luggage in which the luggage lock is integrated so that a subsequent owner of the luggage lock does not himself/herself have to ensure that a non-destructive opening of the luggage lock is made possible for the security institutions. In general, however, the owner may be enabled to provide an opening code to the security institution only for the period of a journey or to activate said opening code only for such a time period, as will be further explained below.

In particular, due to such a provision of an opening code in a database, it may be avoided that a separate locking mechanism, which may be actuated by employees of the security institutions and in any case generally offers a point of attack for manipulations, has to be provided for a non-destructive opening of the luggage lock. Both the owner and employees of the security institution may rather open the luggage lock by transmitting the opening code and controlling the electromechanical locking mechanism so that the number of possibilities of opening the luggage lock in principle may be reduced compared to conventional solutions and the security against manipulation of the luggage lock may be increased. In this regard, in some embodiments, the luggage lock may comprise only the electromechanical locking mechanism and no further locking mechanism, in particular no mechanical locking mechanism by which the securing section of the piece of luggage may be selectively locked or released relative to the luggage lock.

The electronic luggage lock thus makes it possible, on the one hand, to permit the opening for a selected group of persons and in particular employees of a security institution, wherein manipulations of the luggage lock or an opening of the luggage lock by unauthorized persons may, however, be reliably counteracted, in particular by an appropriate securing of a database in which the opening code is or will be stored. For example, requests for an opening code may only be enabled by opening devices that are authorized by the security institution and that may be associated with respective employees of the security institution at least temporarily, for example during a duty shift. For this purpose, a device identification may, for example, be transmitted to the database in addition to a request for the opening code so that it may be checked whether the request originates from an authorized opening device.

Furthermore, when the opening code is requested, a legitimation check may, for example, take place during which an employee of the security institution must, for example, prove the legitimation for requesting the opening code by entering a password at the opening device. Alternatively or additionally, an identity check of a requesting employee or another person may also take place, for which purpose, for example, a biometric check, such as a fingerprint check or facial recognition, may be provided at the opening device by which the opening code is requested. In general, the requesting of the opening code may further take place via an app installed on a smartphone or another opening device, wherein access to the app may already be dependent on a legitimation check and/or identity check. Alternatively to using a smartphone, provision may also be made that the security institution provides its own opening devices that are specifically configured for the communication with the database and an opening of luggage locks.

Furthermore, any requests for the opening code may be documented in the database so that it may be traced whether, for example, an opening attempt and in particular a check have taken place after the piece of luggage was handed in at an airline counter. Therefore, even in the event of a manipulation of the database through which an unauthorized person gained access to the opening code, it may generally be traced that the luggage lock was opened after the piece of luggage was handed in so that the owner of the piece of luggage may, for instance, exonerate himself/herself of the suspicion that he or she had already originally carried prohibited substances and/or items. This may again also relieve the security institutions in that, in the event that a prohibited item is found in a piece of luggage, unnecessary capacities for prosecuting the innocent owner of the piece of luggage do not have to be used. Furthermore, in the course of documenting requests for the opening code, information about the requesting device and/or a location of the request may, for example, also be documented in order, even in the case of a manipulation of the database, to be able to provide data that may help to clear up a theft or smuggling.

Since the luggage lock has a memory in which the release code is stored, it is furthermore also possible to document transmissions of opening codes alternatively or additionally in the memory of the lock. This may in particular enable the owner, also in the event of a possible manipulation of the database of a security institution, to trace and prove opening attempts that in particular took place after the piece of luggage was handed in so that a reliable detection and tracing of opening attempts may be achieved by a potentially double documentation of such opening attempts or processes within the lock, on the one hand, and within the database, on the other hand.

The code receiving device and/or the control device may generally comprise a radio device or be connected to a radio device to be able to receive the opening code from the opening device. For example, provision may be made that the code receiving device and/or a radio device connected to the code receiving device is/are configured to receive the opening code via a Bluetooth connection or an NFC (near field communication) connection. Such connections may in particular be provided since these connections only enable a communication over relatively short ranges so that the luggage lock may only be opened when the owner or another person who has the opening code is in the immediate vicinity of the piece of luggage. On the other hand, persons standing at a distance from the piece of luggage cannot open the luggage lock and it may, for example, be ensured that the owner of the luggage lock or another person standing at a distance cannot have opened the luggage lock after it was handed in at a check-in counter in order to enable a subsequent adding of items by third parties. Alternatively thereto, it is, however, for example, also possible that the code receiving device is configured to receive the opening code via a WLAN/WiFi connection and/or a mobile radio connection.

In summary, such an electronic luggage lock first offers its owner a convenient possibility of opening the luggage lock by transmitting the opening code by an opening device and in particular a smartphone which is available anyway and on which, for example, a corresponding app may be installed. Furthermore, a likewise convenient possibility of opening the luggage lock without destruction may, however, be offered to employees of a security institution by storing a data pair of the opening code and the lock identification code, via which data pair the luggage lock may be individually identified, in a database readable by the security institution. An employee of the security institution may then, during a check, read the lock identification code by an opening device of the security institution, in particular likewise a smartphone with a corresponding app, and transmit it to the database in order thereupon to request the opening code and to open the luggage lock without destruction after receiving the opening code.

The reading of the identification device may in particular take place in a convenient manner by the opening device and/or a smartphone in that the lock identification code may, for example, be optically readable or may be provided in a wirelessly detectable electronic form. For example, the lock identification code may be provided as a QR code, applied by laser engraving, at an outer side of the luggage lock so that the lock identification code may be scanned by an employee of the security institution by the opening device and the opening code may thereupon be queried from a database of the security institution. Such a reading of the lock identification code by the opening device or smartphone may likewise be made possible if the lock identification code may be read via a radio connection and may, for example, be detected by the opening device via a WLAN/WiFi connection, via a Bluetooth connection, via a mobile radio connection or via an RFID (Radio Frequency Identification) connection, in particular via an NFC (Near Field Communication) connection.

Furthermore, such a provision of opening codes in a database of the security institution enables an extended check in that the opening code-unlike in the conventional solution with special keys available to every employee-may, for example, only be made available to a selection of employees, for example employees stationed along a travel route, so that the group of persons who potentially have access to the piece of luggage may be limited as far as possible. Such information about the travel route may, for example, be transmitted to the security institution, and in particular to a database in which the opening code is also stored, before the start of the journey by the owner of the piece of luggage or also during or after the check-in by the respective airline. This may, for example, take place in that the airline also reads the lock identification code and transmits it to the database together with a flight number, for example.

Since the securing section of the piece of luggage may be locked by the locking mechanism, a closed state of the piece luggage may in particular be secured against an opening by unauthorized third parties. Therefore, provision may generally be made that the luggage lock or a part of the luggage lock, on the one hand, and the securing section of the piece of luggage, on the other hand, are movable relative to one another when the securing section is released. This may in particular make it possible to selectively transfer the piece of luggage to an open state, for which purpose the luggage lock may, for example, be arranged at a first part of the piece of luggage and the securing section may be arranged at a second part of the piece of luggage. By locking the securing section, such a relative movement of the two pieces of luggage may, however, be prevented to prevent access to an inner space of the luggage.

For example, the securing section of the piece of luggage may be a movable handle of a zipper by which the zipper may be selectively opened or closed, wherein access to an inner space of a luggage body of the piece of luggage may take place by opening the zipper. On the other hand, the movable handle of the zipper may be lockable relative to the luggage lock by the electromechanical locking mechanism after the zipper is closed to prevent a non-destructive opening of the zipper and to secure the closed state of the piece of luggage. In this case, the locking of the securing section or the handle of the zipper thus prevents an opening of the zipper by which two pieces of luggage may be connected to one another so that the piece of luggage cannot be opened. For this purpose, the luggage lock may, for example, be connected to or arranged at one of the pieces of luggage, wherein alternatively thereto it is also possible for the luggage lock to be releasable from the piece of luggage. Such a releasable luggage lock may, for example, be configured as a padlock having a, for example, U-shaped hoop that may be guided through two eyelets of handles of the zipper to thereby connect the handles to one another. To lock the securing section of the piece of luggage or the handles of the zipper relative to the luggage, the hoop may thereupon be introduced into a lock body and locked therein so that the handles cannot be removed from one another and the zipper cannot be opened.

Alternatively thereto, the securing section may, for example, be formed by an engagement strip of a buckle closure that may be locked by the electromechanical locking mechanism. In this respect, the locking may in particular take place indirectly in that the buckle closure may be blocked against a release from the engagement strip by the electromechanical locking mechanism. For example, a catch of a buckle, by whose actuation an engagement behind the engagement strip may be released, may be blockable by the electromechanical locking mechanism for this purpose. The luggage lock may in particular be integrated into a buckle of the buckle closure in such pieces of luggage.

Furthermore, in some embodiments, the securing section may be provided as a stationary hoop at the piece of luggage, wherein such a hoop may in particular be configured as a bolt at a movable part of the piece of luggage. For example, in the course of closing the piece of luggage, such a securing section may be introduced into an introduction opening at another part of the piece of luggage and may be locked there by the electromechanical locking mechanism in order to lock the securing section relative to the luggage lock and thereby to secure the closed state of the piece of luggage.

Furthermore, a piece of luggage may generally have a closure, for example a buckle closure having a buckle and an engagement strip, a zipper, a stationary bolt, a hoop, or an engagement opening of a lock environment, wherein the closure may enable an opening of the piece of luggage in an open position and may keep the piece of luggage closed in a closed position. The securing section may in particular be a part of the closure. In such pieces of luggage, the electromechanical locking mechanism may therefore in particular selectively lock the closure in the closed position or release the closure for a movement into the open position. However, the movement of the closure into the open position may thereupon generally take place manually, whereas the release for said movement or the unlocking of the closure or securing section may take place by the electromechanical locking mechanism. Such a closure may also be integrated into the luggage lock to provide a holding function in addition to the locking function so that the piece of luggage may be kept closed but may be opened by any third party.

The electromechanical locking mechanism may, for example, comprise an actuator, in particular an electric motor, and a latch driven by the actuator, wherein the latch may cooperate directly or indirectly, for example via a preloaded catch, with the securing section of the piece of luggage to be able to selectively lock the securing section of the piece of luggage relative to the luggage lock.

The control device may comprise a single electronic unit or have a distributed design, wherein different sections of the control device may be responsible for different control tasks. The control device may, for example, comprise one or more of the following devices: an integrated circuit (IC), a microprocessor, or an application-specific integrated circuit (ASIC).

The memory may further be a part of the control device or be formed separately therefrom. The memory may in particular be a non-volatile memory, for example a semiconductor memory, and/or the memory may, for example, be configured as an EEPRON.

A lock identification code that is individually associated with a luggage lock can—with respect to the present disclosure—in particular be genuinely associated with said luggage lock and/or can, for example, be generated and deposited in or attached to the identification device by a manufacturer of the luggage lock. Further, the lock identification code can be in particular immutable in some embodiments. The lock identification code can, thus, be permanently and unalteredly associated with the luggage lock, while the opening code and/or the release code may—where applicable—be changeable, as will be explained in more detail below. Further, the lock identification code may in particular be associated with the luggage lock already at the point in time at which the luggage lock is delivered by the luggage manufacturer, such that the lock identification code may in particular not be subsequently (after the delivery) or selectively generable, in particular neither by the owner of the luggage lock nor by a security institution meant to be able to open the luggage lock without destruction. In case reference is made to a lock identification code in the present disclosure, the lock identification code is in general to be understood as being individually associated with a luggage lock to facilitate an identification of said luggage lock.

Further embodiments are explained in the claims, in the description, and in the drawings.

In some embodiments, the identification device may provide the lock identification code in an optically readable form and/or in a wirelessly detectable electronic form. A lock identification code provided in an optically readable form may in particular comprise a numerical sequence and/or letter sequence, a QR (Quick Response) code or a bar code that may be scanned by an employee of a security institution, in particular using the opening device also provided for transmitting the opening code to the code receiving device, and may thereby be easily transmitted to a database for querying the opening code. In this regard, in some embodiments, the lock identification code may comprise an optical one-dimensional or two-dimensional optically readable code. A lock identification code provided in a wirelessly detectable electronic form may in particular be read via a radio connection, for example via a WLAN/WiFi connection, via a Bluetooth connection, via a mobile radio connection or via an RFID (Radio Frequency Identification) connection, in particular via an NFC (Near Field Communication) connection, wherein this reading may also in particular take place directly by the opening device provided for transmitting the opening code to the code receiving device. However, the lock identification code may in particular be read by the opening device via a different channel than via the wireless connection to the code receiving device.

For example, an optically readable lock identification code may be formed by a laser engraving at an outer side of the luggage lock and/or at a housing of the luggage lock. A wirelessly detectable electronic lock identification code may, for example, be provided in an NFC tag or RFID tag, wherein an NFC tag may in particular have a passive transponder that may be controllable by electrical energy wirelessly provided by the opening device to output the stored lock identification code. The lock identification code may therefore be stored in a memory of such an NFC tag or of a passive transponder. Another RFID tag may furthermore also have an active transponder that is powered by its own electrical energy source to be able to output the lock identification code stored in a memory of the RFID tag or transponder over a greater range compared to an NFC connection. However, with such an active transponder, provision may also be made to activate the energy source only by a signal wirelessly received from the opening device in order to provide energy for transmitting the lock identification code only if necessary, but to avoid an unnecessary energy consumption.

The luggage lock may generally be designed such that it complies technically, and in particular with respect to the energy supply, to any requirements imposed by airlines and legislators, according to which devices comprising rechargeable batteries and/or accumulators have to be switched off during a flight and secured against unintentional activation. This may, for example, take place in that an energy supply for the electromechanical locking mechanism, the control device, the code receiving device and/or the identification device may be selectively activated or deactivated via a button and/or an activation or deactivation command that may in particular be wirelessly received at an active or passive transponder. In the course of a check, an employee of the security institution may activate the energy supply by actuating the button or sending an activation command in order, after reading the lock identification code and requesting and receiving the associated opening code, to be able to open the luggage lock without destruction by transmitting the opening code to the code receiving device.

In some embodiments, provision may in particular be made that the energy supply for the electromechanical locking mechanism, the control device, the code receiving device and/or the identification device may be activated via a button or an activation command and that the control device is configured to deactivate the energy supply again after a predefined time period following an activation and/or as a result of an interruption of a connection to an opening device. In such embodiments, an energy-saving sleep mode may thus in particular be provided as a basic mode for the luggage lock in which the luggage lock is switched off and an energy consumption is avoided so that before the luggage lock is actuated to lock or release the securing section, the energy supply first has to be activated to then be able to open the luggage lock, for example, by transmitting the opening code. Due to such a procedure, an unnecessary energy consumption may in particular be avoided at times at which the luggage lock is to remain in a previously set state and, on the other hand, it may be ensured that the luggage lock is reliably switched off during a transport or flight without the owner having to take care of the switching off himself/herself. This may, for example, take place by storing a time period in a control of the luggage lock, wherein the luggage lock may be automatically switched off after this time period has elapsed following an activation. Alternatively thereto, the energy supply may, for example, be deactivated as soon as a connection to an opening device, from which an opening code or another control command was previously received, has been interrupted and the luggage lock or piece of luggage has thus been removed from the opening device.

Furthermore, it is possible that the opening code and/or another control command that may be transmitted by the opening device comprises/comprise an activation command for activating the energy supply. For example, such an activation command may be transmitted as part of the opening code to an active or passive transponder of the luggage lock, wherein, as a result of the received activation command, the energy supply of one or more of the above-mentioned components may be activatable by, for instance, closing a corresponding circuit when the transponder is being energized. In this regard, it may be sufficient in some embodiments to transmit the opening code to the code receiving device, wherein the energy supply of the lock may be activated by the activation command transmitted together with the opening code so that no command to be transmitted separately or the actuation of a separate button has to be necessary.

In some embodiments, the code receiving device may be configured to receive the opening code via a Bluetooth connection and/or an NFC (Near Field Communication) connection. The receiving via such a connection may in particular make it possible that the luggage lock may only be opened by persons and/or opening devices located in the vicinity of the luggage lock so that a remote manipulation or opening of the luggage lock may be ruled out. For example, the receiving of opening codes with such a connection may be limited to a few meters, for example 2 m, or distances of less than 1 m.

In some embodiments, the opening code may be transmittable to the code receiving device by a command at the opening device, wherein provision may alternatively thereto be made that the opening code may be transmitted by moving the opening device into the vicinity of the luggage lock. Furthermore, provision may, for example, be made that the opening code is only directly transmitted when an opening device of the owner of the luggage lock is moved into the vicinity of the code receiving device, whereas at least the command for querying the opening code from the database may be required for the opening of the luggage lock by an employee of a security institution. To enable only the owner of the luggage lock to open it directly, in particular a device identification of the opening device of the owner may be storable in the memory in addition to the release code so that the transmission of the corresponding device identification by the opening device of the owner may enable an automatic coupling to the luggage lock and the electromechanical locking mechanism may be controlled to release the securing section of the piece of luggage. In this regard, a device identification of the opening device of the owner of the piece of luggage may act as an opening code in some embodiments.

In some embodiments, the control device may be configured to change the release code stored in the memory in response to a code change command received from the opening device in a code change operation mode.

For example, the control device may be configured to replace the release code in response to the code change command, to add a further release code, or to delete the stored release code. The code change command may in particular also be received via the code receiving device and transmitted to the control device, wherein a separate radio module may, however, also be provided for receiving the code change command.

Such a change of the release code may, for example, enable an owner of the luggage lock to make the release code available to the security institutions for a specific release period, but to ensure after the release period has elapsed that the luggage lock may only be opened by the owner himself/herself and not by persons who gain access to a database of the security institution. For this purpose, the stored release code, which comprises an opening code provided to the security institutions for the period of a journey, may, for example, be deleted from the memory of the luggage lock or changed after the journey has been completed so that the luggage lock may no longer be opened by the opening code stored in the database after the journey has been completed and/or the piece of luggage has been received. The owner of the luggage lock may thereby be offered a possibility of protecting himself/herself against unauthorized access to the piece of luggage or a theft of items taken along even if the measures for securing the database of the security institution are overcome and the opening code is read in an unauthorized manner. When starting a further journey, the owner may, for example, selectively again provide a changed release code to the security institutions by transmitting a corresponding opening code to the database in order, if necessary, to enable a non-destructive opening of the luggage lock by an employee of the security institution.

Furthermore, provision may be made for the owner to add a further release code to the memory in the course of changing the release code since, in some embodiments, a respective release code may be provided for the owner and for the security institution so that, for example before the start of a journey, a further release code associated with the opening code of the security institution may be stored in the memory and may, for example, be deleted again after the completion of the journey.

As an alternative or in addition to directly changing the release code or a release coding included in the release code, provision may, however, also be made that the stored release code comprises information about a release period while the lock may be opened by transmitting a matching opening code. In this regard, the changing of the release code may, for example, also take place by the owner of the luggage lock specifying such a release period to enable the security institutions to access the piece of luggage for the expected time period of a journey, but not beyond it. Before starting a further journey, the owner may then, for example, change the release code again by setting a new release period corresponding to the expected time period of the further journey to enable the security institutions to access the piece of luggage for this release period.

Furthermore, provision may be made that the release code may be selectively activated or deactivated by the owner of the luggage lock and may be changed in this regard so that the owner may, for example before starting a journey, activate the release code and may thus enable a non-destructive opening by the security institutions, but may rule out external access to the piece of luggage after receiving the piece of luggage by changing and deactivating the release code. Since the change and in particular the activation or deactivation of the release code may take place directly at the luggage lock, the owner may again, irrespective of a previous transmission of the opening code, freely decide whether or not to grant the security institutions access to the piece of luggage and at what times.

In some embodiments, the control device may be configured to distinguish between an owner authorization of the owner of the piece of luggage and an authority authorization of a security institution, wherein the control device may be configured to only change the release code stored in the memory when the control device determines the owner authorization.

Due to such a design of the control device, it may in particular be achieved that the release code may be changed solely by the owner, but not by an employee of the security institution and in particular not by persons who have gained unauthorized access to a database in which the opening code is stored. For example, such an owner authorization may be checked in that a device identification relating to the opening device of the owner may be stored in the memory of the luggage lock and the code change command is only executed if the code change command was transmitted by an opening device associated with the device identification and thus by the opening device of the owner of the luggage lock. This device information, by which the opening device or the smartphone of the owner may so-to-say be identified as a “trusted device”, may in particular be stored in the memory during an initialization process during which the luggage lock is connected and/or coupled to the opening device of the owner for the first time. Furthermore, provision may be made that in addition to the transmission of the opening code, a device identification is also always transmitted to the code receiving device to achieve a distinction between an owner authorization and an authority authorization. Alternatively to checking the respective authorization by storing a device identification, provision may also be made that a legitimation check or an identity check at the opening device is required for transmitting the code change command in that, for example, a password has to be entered or a fingerprint check or facial recognition takes place. Such a legitimation check or identity check may in particular take place at the opening device or within the luggage lock in that a password may, for example, be stored in the memory of the luggage lock so that a password may be transmitted together with the code change command and may be compared with the stored password by the control device of the luggage lock. If, on the other hand, the check of the owner authorization takes place at the opening device, for example by entering a password in an app or by an identity check, the respective part of the control device of the luggage lock that is provided for checking the owner authorization may ultimately be integrated into the opening device.

Whereas, by checking and distinguishing between an owner authorization and an authority authorization, it may thus be achieved that only the owner may change the release code, the opening of the lock by transmitting the opening code may be possible for both authorization levels. However, also with regard to the opening of the luggage lock, the various authorization levels may possibly be assigned different possibilities in that the luggage lock may, for example, always be opened when the owner authorization is determined, but may only be opened during a specified release period when the authority authorization is determined. This is explained in more detail below.

The communication between the opening device of the owner and the luggage lock and/or the communication between the opening device of the owner and the database may take place in encrypted form.

In some embodiments, the release code may be activatable and/or deactivatable by the code change command. For example, provision may be made that an owner unlocks an opening code stored permanently, and for example already originally by the lock manufacturer, in a database readable by the security institutions by activating a corresponding release code before the start of a journey, and thereby enables the security institutions to open the luggage lock or the piece of luggage without destruction, in order, however, to deactivate the release code again after the piece of luggage has been received and to ensure that the luggage lock may only be opened by the authorized owner. In such a procedure, provision may furthermore be made that, when the release code is deactivated, the luggage lock may only be opened by transmitting the opening code if, in addition to the opening code, the owner authorization already mentioned is detected, for example via a stored device identification.

In some embodiments, the code change command may include an instruction for changing the release code. For example, the code change command may comprise an instruction for changing and/or setting a release period during which the luggage lock may be opened by an employee of the security institution by transmitting an opening code that matches the release code to enable the security institutions to open the luggage lock for this release period. Alternatively or additionally, the code change command may, however, also comprise an instruction for changing a release coding, in particular a code number, wherein, for this purpose, a corresponding code number may, for example, be transmitted directly by the code change command to the luggage lock or an instruction for generating a changed code number may be transmitted. Provision may therefore be made that the control device, in response to the code change command, generates a changed release code, stores it in the memory and/or transmits it to the opening device of the owner via an interface, for example a radio module of the code receiving device. By changing the release coding in this way, an owner may, for example, achieve that a release coding possibly stored in a database no longer at all matches the release coding of the release code stored in the lock so that the luggage lock also cannot be opened if there is unauthorized access to the database. However, the changed release code and in particular the changed release coding may thereupon, for example before the start of a further journey, be transmitted to the database of the security institutions again.

In some embodiments, the release code may comprise a release coding and information about a release period, wherein the control device may be configured to control the electromechanical locking mechanism to release the locked securing section if the received opening code comprises the release coding and the opening code was received within the release period.

The release coding may in particular comprise a code number or a number or a numerical sequence and/or letter sequence that may be stored in a database of a security institution so that the release coding may be transmitted as part of the opening code to the code receiving device and may be compared with a stored release coding, a corresponding code number, a number or a numerical sequence and/or letter sequence. However, an opening of the luggage lock by transmitting the release coding may be granted to the security institution only for a predetermined release period so that a reading of the release coding from a database after the release period has elapsed and a transmission of the release coding to the code receiving device no longer results in an opening of the luggage lock. To check whether the release coding or the opening code was received within the release period, the lock may in particular have its own clock or time measuring device so that any manipulations of a clock of the opening device that transmits the opening code may be prevented and the check of the release period may be performed independently of time information transmitted by the opening device. However, it is also possible to use time information transmitted by the opening device to check the release period.

Furthermore, in some embodiments, the code receiving device may be configured to receive a device identification from the mobile opening device and the control device may be configured to compare the received device identification with an owner identification stored in the memory and to control the electromechanical locking mechanism independently of whether the opening code was received within the release period to release the locked securing section if the received opening code comprises the release coding and the received device identification matches the stored owner identification.

The owner identification may in particular be stored in the memory during an initialization process and/or a first coupling of the opening device of the owner to the luggage lock so that the opening device of the owner may so-to-say be identified as a “trusted device” by which the luggage lock may be opened at any time. If the owner subsequently transmits the opening code with the release coding as well as the device identification matching the owner identification to the code receiving device, the control device may determine the owner authorization and the luggage lock may be opened at any time. Other opening devices or opening devices that transmit a device identification other than the owner identification with the opening code may, on the other hand, be enabled to open the luggage lock only during a release period that may be determined by the owner. For this purpose, information about the release period may in particular be stored in the memory of the luggage lock.

Compared to the known mechanical solutions, such a procedure thus offers increased security in that access to the piece of luggage by persons other than the owner may only be enabled during the release period and, for example, the duration of a journey, whereas after the completion of the journey, even in the event of an unauthorized reading of the opening code and the release coding from the database—which is ultimately comparable with the reproduction of a master key in the known mechanical solutions—, the storage of the release period in the memory of the luggage lock may prevent unauthorized access to the piece of luggage and, for example, a theft from taking place. A setting of a release period may in particular also take place indirectly by activating and deactivating the release code in that an owner may, for example, activate the release code when handing in a piece of luggage at a check-in counter and deactivate it again after receiving the piece of luggage.

In some embodiments, the control device may be configured, in the code change operation mode, to change the release coding and/or the information about the release period. As already explained, a changed release coding may, for example before the start of a journey, be stored in the memory of the luggage lock and transmitted to a database readable by the security institutions to enable a non-destructive opening of the luggage lock. In addition or alternatively to a changed release coding, information about the release period may be stored in the memory of the luggage lock and/or transmitted to the database so that the receiving of an opening code that comprises the release coding only leads to an opening of the luggage lock if the opening code was detected within the release period. Furthermore, only the release period, but not the release coding, may also be changed to enable the security institutions to open the luggage lock for the release period. For this purpose, the release coding may, for example, already have been stored beforehand, in particular also by a manufacturer of the luggage lock, in a database readable by the security institutions. The information about the release period may generally also only be changed in that a release coding stored in a memory of the luggage lock is activated or deactivated by the owner of the luggage lock.

In some embodiments, the control device may be configured to delete the release code from the memory of the luggage lock after the release period has elapsed. In such embodiments, provision may in particular be made that a further release code is stored in the memory that is, however, only available to the owner so that the owner may open the luggage lock at any time. However, since the release code, whose associated and/or corresponding opening code may, for example, be transmitted to a database of a security institution, may be deleted after the release period has elapsed, it may be ensured that even unauthorized access to the database and/or a manipulation of information about a point in time at which an opening code is transmitted does not allow the luggage lock to be opened without authorization. However, to again enable the security institutions to open the luggage lock without destruction during a further release period and/or before the start of a further journey, a new release code or the original release code with a release period adapted to the journey may, for example, be stored in the memory of the luggage lock by the code change command already mentioned and—in particular in the case of a changed release code—transmitted to a database readable by the security institutions.

In some embodiments, a first release code and a second release code may be stored in the memory, wherein the control device may be configured to control the electromechanical locking mechanism to release the locked securing section if the received opening code matches the first release code or the second release code.

Furthermore, in such embodiments, the control device may be configured, in the code change operation mode, to change only the first release code, but not the second release code, in response to the code change command.

In such embodiments, provision may consequently be made to keep a second release code available in the memory that is unchangeable and that is only available to the owner of the luggage lock to enable the owner to open the luggage lock at any time. Furthermore, a selectively changeable and/or activatable second release code may, however, be stored which the owner may selectively make available to the security institutions. In this regard, the changeable first release code may, for example, be transmitted as an opening code to a database readable by the security institutions, whereas the unchangeable second release code may be stored solely in the memory of the luggage lock and/or transmitted solely to the opening device of the owner during an initialization process for the first coupling of the opening device to the luggage lock. Alternatively thereto, the second release code may also comprise a device identification of the opening device of the owner in order, for example, to enable a direct opening of the luggage lock when the opening device of the owner is in the vicinity of the luggage lock. In this regard, the first release code may, for example, also be written to the memory during an initialization process.

Furthermore, in some embodiments, the first release code may comprise a first release coding and the second release code may comprise a second release coding, wherein the first release code may furthermore comprise information about a release period. The control device may be configured to control the electromechanical locking mechanism to release the locked securing section if the opening code comprises the first release coding and the code receiving device receives the opening code within the release period or if the opening code comprises the second release coding. The transmission of the second release coding may therefore always enable the owner of the luggage lock to open the luggage lock, whereas an opening of the luggage lock by transmitting the first release coding is only possible when an opening code comprising the first release coding is received during the release period.

In some embodiments, a master code may be permanently stored in the memory, wherein the control device may be configured, in response to an initialization command received from the opening device, to compare an initialization code included in the initialization command with the stored master code and to store a device identification included in the initialization command and relating to the opening device as an owner identification in the memory if the received initialization code matches the stored master code. Such an initialization code may in particular serve to enable a first coupling between an opening device of the owner and the luggage lock and/or to assign the owner identification already mentioned to the opening device of the owner, for example, to enable the owner to change the release code and/or to open the luggage lock irrespective of a release period. Furthermore, as a result of the initialization process, the aforementioned second release code may, for example, be transmitted to the opening device of the owner to enable an opening of the luggage lock by the opening device of the owner at any time. The initialization code may, for example, be readable at an initialization card supplied with the luggage lock.

In some embodiments, the luggage lock may comprise a mechanical locking mechanism that is configured to selectively lock or release the securing section of the piece of luggage while bypassing the electromechanical locking mechanism.

In such luggage locks, a mechanical override may in particular be provided for the owner in that the owner of the luggage lock may, for example, actuate the luggage lock by an associated mechanical key or by actuating a combination locking mechanism and/or entering a numerical sequence and/or letter sequence. On the other hand, by providing the opening code, employees of the security institutions may be enabled to open the luggage lock without destruction by transmitting the opening code to the code receiving device and actuating the electromechanical locking mechanism. Thus, the mechanical locking mechanism may in particular not have to be actuated by a special or master key that is available to the security institutions, but, unlike in conventional solutions, may enable an opening of the luggage lock only by the owner. In such embodiments, provision may furthermore be made that the owner may also open the electromechanical locking mechanism by transmitting the opening code, as explained above, wherein alternatively thereto it is, however, also possible that only the mechanical locking mechanism is available to the owner and the actuation of the electromechanical locking mechanism is reserved for the security institutions. Such a luggage lock with a mechanical override in particular enables the owner to be able to open the luggage lock even if no opening device is taken along and/or an electrical energy source for the supply of the electromechanical locking mechanism and/or the control device is exhausted.

In other embodiments, provision may, however, be made that the luggage lock only has a single locking mechanism, the electromechanical locking mechanism, with respect to possibilities for locking and releasing the securing section so that the opening of the luggage lock by the owner and the security institution may take place by actuating the same locking mechanism.

In some embodiments, the luggage lock may comprise a clock. Due to the configuration of the luggage lock with a clock, it may in particular be achieved that the aforementioned release period may be checked directly by the control device of the luggage lock and that it is not necessary to resort to time information that is transmitted by the opening device and that could generally be manipulated. The clock of the luggage lock may in particular be configured to measure an absolute time indication consisting of time and date in one or more time zones and/or to stop a time to be able to check a release period stored as an absolute time indication and/or a release period stored as a release duration starting from a specific start time.

In some embodiments, the control device may be configured to document the receiving of the opening code in the memory. For example, the memory may for this purpose comprise a database in which the receiving of the opening code may be documented. The memory may further comprise one or more memory units so that the receiving of the opening code may, for example, be documented in a memory unit in which the release code is also stored or in a separate memory unit of the memory.

Due to this documenting of the receiving of opening codes, it may in particular be documented whether the luggage lock has, for example, been opened by an employee of the security institution after it was handed in at a check-in counter. This enables an owner of the luggage lock, on the one hand, to track whether the luggage lock was opened in the course of a check, but, on the other hand, also to prove, for example, that an opening code was received after the piece of luggage was handed in at a check-in counter and before the piece of luggage was received again to be able to exonerate himself/herself from the possible suspicion of carrying prohibited substances and/or items. The control device may furthermore also be configured to transmit a message about a received opening code to the opening device of the owner of the luggage lock on a next coupling if an opening code was received in the meantime from an opening device other than that of the owner to inform the owner about the opening of the luggage lock.

In some embodiments, the control device may be configured to document, in the memory, a point in time at which the opening code was received and/or information about the mobile opening device and/or information about a location at which the opening code was received.

For example, the luggage lock may have a location determination device, such as a GPS device, or location information may be received together with the opening code from the transmitting opening device to document, in the memory, information about the location at which the opening code was received. Thus, provision may in particular be made to document as completely as possible, in the memory of the luggage lock, at which point in time an opening code was received by which device and/or by which person at which location in order, for example, to be able to determine or prove at which stopover the piece of luggage was checked by which employee of a security institution and at what time. In general, such data may furthermore also be documented in a database of the security institution, wherein, by a documentation within the luggage lock, the owner may, however, be enabled to trace opening processes independently of a correct documentation in the database.

In some embodiments, the luggage lock may be configured to detect mechanical opening attempts, for example, by detecting relative movements of two sections of the piece of luggage (including the luggage lock). In such embodiments, the luggage lock may in particular comprise a sensor that is configured to directly or indirectly detect a movement of the securing section of the piece of luggage relative to the luggage lock and to transmit a corresponding detection signal to the control device. In some embodiments, the control device may be configured to document the receiving of the detection signal in the memory.

For example, the sensor may be configured to indirectly detect a movement of the securing section of the piece of luggage when a change in position of a released catch of the luggage lock that is pushed back by the securing section is detected. Alternatively, a securing section directly lockable by a latch of the locking mechanism may, however, also contact the sensor when the securing section is locked so that the sensor may be configured to detect both this contact of the securing section and a breaking off of the contact. Such a sensor may in particular also be provided to transmit a detection signal to the control device when the securing section of the piece of luggage is detected by the sensor in a position in which a locking may take place so that the control device may directly control the locking mechanism to lock the securing section in response to the detection signal.

Said sensor may, for example, comprise a mechanical contact switch, a capacitive sensor, or a magnetic sensor.

Since the control device may document the receiving of the detection signal in the memory, it may in particular also be documented whether the luggage lock or the piece of luggage has actually been opened. Therefore, a distinction may be made between cases in which an opening code was indeed received, but the luggage lock remained locked, and cases in which access to an inner space of the piece of luggage took place. In addition to the receiving of the detection signal, the point in time and/or the location at which the detection signal was detected and the luggage lock and/or the piece of luggage was/were opened may also be documented again.

In some embodiments, the memory may be connected to an interface via which the memory may be wirelessly read. This interface may in particular be formed by a radio module of the code receiving device so that the owner may read the memory by a mobile opening device and may trace any opening attempts. Furthermore, in some embodiments, the memory may, however, only be readable when the already mentioned owner identification is determined, in particular based on device information stored in the memory, so that the memory of the luggage lock may only be read by the owner himself/herself. The memory, in which, for example, personal information, such as location and/or time indications at which the owner opened the luggage lock himself/herself, may also be stored, may therefore not be readable by the security institution, wherein, however, the security institutions may, if necessary, themselves document requests for the opening code to a database readable by the security institution to be able to trace opening attempts by their own employees.

In general, data and/or information stored in the memory of the luggage lock may further be stored in encrypted form to prevent a reading by unauthorized persons.

In some embodiments, the luggage lock may comprise an energy source for the energy supply of the electromechanical locking mechanism and/or the control device. For example, the luggage lock may comprise an accumulator, a battery, and/or an induction receiver for this purpose. The memory, the code receiving device and/or the identification device may also be supplied with the required energy via this and/or a separate energy source, if necessary.

Furthermore, in some embodiments, provision may be made that the luggage lock is energizable from the outside, in particular solely from the outside, and does not have an internal energy source storing electrical energy for the supply of the electromechanical locking mechanism. For example, in a configuration of the luggage lock with an induction receiver, provision may be made that the luggage lock may be energized solely by electromagnetic radiation wirelessly transmitted by the opening device in that a current flow for the supply of the electromechanical locking mechanism, the control device and/or the code receiving device may be induced by the radiation.

In some embodiments, the control device may be configured to transmit an energy supply state signal to the opening device. The control device may in particular be configured to transmit an alarm to an opening device of the owner of the luggage lock when the energy source is nearly exhausted to remind the owner to charge and/or replace the energy source. This may, for example, take place via a mobile radio connection and/or a WLAN/WiFi connection.

In some embodiments, the luggage lock may have a charging socket, in particular a USB (Universal Serial Bus) socket, and/or an induction receiver, via which charging socket and/or induction receiver the electromechanical locking mechanism may be supplied with electrical energy by an external energy source, in particular the opening device.

In this regard, a possibility may be provided to be able to supply energy to and to actuate the electromechanical locking mechanism even when the internal energy source of the luggage lock is exhausted. In this respect, provision may in particular be made that the electromechanical locking mechanism may be connected to the mobile opening device via a cable, for example via a USB cable, to obtain energy from the mobile opening device, wherein, alternatively to a cable-based energy supply, an induction of an electric current at an induction receiver by electromagnetic radiation transmitted by the opening device may also be provided. This may enable both the owner and an employee of a security institution to supply energy to and to actuate the electromechanical locking mechanism when the internal energy source of the luggage lock is exhausted without a separate energy source being required for this purpose, apart from the opening device anyway required for opening the luggage lock. Provision may therefore also be made that the control device is configured to transmit information to the opening device of an employee of a security institution when the internal energy source of the luggage lock is exhausted and an external energy source is required, provided that the opening device is located in the vicinity of the luggage lock. The transmission of such information may, for example, take place via a passive transponder that may send the corresponding information to the opening device as a result of an attempt to transmit the opening code to the code receiving device.

In some embodiments, the luggage lock may comprise a button by whose actuation the code receiving device may be activated to receive the opening code. Such a button may in particular make it possible to wake up the code receiving device from an energy-saving sleep mode so that the code receiving device does not have to be permanently supplied with energy and it may in particular also be achieved that the energy supply is reliably suppressed and the luggage lock is switched off during a transport or flight. Provision may furthermore be made that the luggage lock comprises an active and/or passive transponder and/or a radio sensor that is configured to detect a coupling of the opening device and consequently to activate an energy supply to the code receiving device.

In some embodiments, the electromechanical locking mechanism may have an actuator and a securing element that is in engagement with the securing section of the piece of luggage in a locking position, wherein the securing element is preloaded in the direction of the locking position, and wherein the securing element is drivable by the actuator in the direction of an unlocking position to release the securing section relative to the luggage.

In such embodiments, provision may in particular be made that, on a movement of the securing section into an engagement region of the securing element, the preloaded securing element automatically enters into engagement with the securing section due to the preload in the direction of the locking position in order to automatically lock the securing section. In such embodiments, the electromechanical locking mechanism may therefore only be controlled to move the securing element in the direction of the unlocking position and to release the securing section for a movement relative to the luggage lock, whereas the locking takes place automatically. In this regard, such a locking mechanism enables an automatic function for locking the securing section when, for example, a buckle of the piece of luggage is closed or a handle of a zipper of the piece of luggage is introduced into a lock environment. Due to such an automatic locking, it may in particular be ensured that the piece of luggage is reliably locked again after a check by the security institutions without an employee of the security institutions having to transmit a separate locking command for this purpose.

Alternatively thereto, in some embodiments with an automatic function of the locking mechanism, provision may also be made that the electromechanical locking mechanism has an actuator, a latch, and a securing element, wherein the securing element is in engagement with the securing section of the piece of luggage in a locking position and is preloaded in the direction of the locking position. In such embodiments, the latch may further be drivable by the actuator in the direction of a blocking position in which the latch blocks the securing element in the locking position to lock the securing section of the piece of luggage relative to the luggage lock. Furthermore, the latch may, however, be drivable by the actuator in the direction of a release position to release the securing element for a movement in the direction of an unlocking position and thereby to release the securing section. In such embodiments, an energy-saving control may thus in particular take place in that the actuator does not have to move the securing element against a preload, but only has to move the latch into a blocking position or a release position. In such embodiments, the securing element may, however, be directly or indirectly manually moved into the unlocking position. To achieve a correct control sequence, a sensor, in particular the already mentioned sensor for detecting a removal of the securing section relative to the luggage lock, may furthermore be provided in such luggage locks to detect the movement of the securing section into an engagement section of the securing element and, as a result, to transmit a signal for moving the latch into the blocking position to the control device. Alternatively thereto, the latch may, however, also be driven into the blocking position as a result of a locking command that may in particular be transmitted by the opening device.

Alternatively thereto, in some embodiments, provision may be made that the electromechanical locking mechanism has an actuator, a latch, and a securing element, wherein the securing element is in engagement with the securing section of the piece of luggage in a locking position, and wherein the securing element is manually moved (directly or indirectly) into both the locking position and the unlocking position. In such embodiments, the latch may be driven by the actuator in the direction of a blocking position in which the latch blocks the securing element in the locking position. In an unlocking position, the securing element may, for example, be held by a force fit (e.g. a latch connection). Furthermore, the latch may, however, be drivable by the actuator in the direction of a release position to release the securing element for a movement in the direction of the unlocking position and thereby to release the securing section.

Furthermore, in some embodiments, provision may be made that the electromechanical locking mechanism has an actuator and a securing element that is in engagement with the securing section of the piece of luggage in a locking position and releases the securing section in an unlocking position, wherein the securing element may be driven by the actuator into the locking position and into the unlocking position. In such embodiments, a direct driving of the securing element both into the locking position and into the unlocking position thus takes place so that an automatic function is not necessarily provided, but the locking may, for example, take place by a corresponding locking command. However, even in such embodiments, an automatic function may, for example, be achieved by a sensor that registers the movement of the securing section into an engagement section of the securing element and, as a result, transmits a signal to the control device for controlling the actuator to move the securing element into the locking position.

In some embodiments, the luggage lock may have a fastening device that is configured to permanently fasten the luggage lock to the piece of luggage. Alternatively thereto, it is, however, also possible for the luggage lock to be selectively releasable from the piece of luggage and to have, for example, a U hoop which may be locked to a lock body and by which two handles of a zipper of the piece of luggage may be connected to one another and, by locking the hoop, may be secured to one another.

The present disclosure further relates to a piece of luggage that comprises a luggage body, having a securing section, a first container part and a second container part movable relative to the first container part between an open position and a closed position, and a luggage lock of the kind disclosed herein. The second container part enables access to an inner space of the luggage body in the open position and blocks access in the closed position. Furthermore, the second container part may be secured in the closed position by locking the securing section.

For example, the second container part may be a pivotable case lid, wherein access to an inner space of the case may be blocked by moving the lid into the closed position and thus closing the case. Since the second container part may be secured in the closed position by locking the securing section, access to the inner space of the luggage body may thereupon be selectively blocked. However, the configuration of the piece of luggage with a luggage lock of the kind described herein makes it possible to identify the luggage lock by reading the identification device and to request the associated opening code so that, for example, an employee of a security institution may open the luggage lock and thus the piece of luggage non-destructively in the course of a check.

The luggage lock may in particular be integrated into the piece of luggage and/or fixedly connected to the piece of luggage so that the luggage lock may in particular not be releasable from the luggage body by releasing the securing section. Alternatively thereto, the luggage lock may, however, for example, also be configured as a luggage lock that may be released from the piece of luggage, for example as a padlock, to be able to selectively secure the two container parts to one another.

In some embodiments, the piece of luggage may have a luggage closure that is configured to keep the second container part in the closed position, wherein the electromechanical locking mechanism may be arranged at the luggage body and the securing section may be arranged at the luggage closure, or vice versa.

As already explained, the luggage closure may, for example, be a buckle or a zipper to be able to connect the two container parts to one another and to hold them at one another. However, as long as the securing section is not locked, such a luggage closure may generally be manually opened so that the luggage closure may in particular prevent an unintentional release of the container parts from one another, but may not prevent manual access to the inner space of the luggage body. Only by locking the securing section may the luggage closure therefore be locked and an opening of the piece of luggage be prevented.

For example, the luggage closure may comprise a buckle that is connected to one of the container parts to engage behind an engagement strip arranged at the other container part after a closing of the piece of luggage and thereby to hold the two container parts at one another. In some embodiments, the electromechanical locking mechanism of the luggage lock may be arranged at such a buckle to lock the engaged-behind engagement strip relative to the luggage lock by blocking an opening movement of the buckle. For this purpose, a catch of the buckle, by whose actuation the engagement behind of the engagement strip may be released, may be blocked by the locking mechanism, for example. Alternatively thereto, in some pieces of luggage, a zipper may, for example, be provided as a luggage closure, wherein its handle or its handles may, as securing sections, be selectively lockable by an electromechanical locking mechanism arranged at a container part to block an opening of the zipper.

In addition to enabling employees of a security institution to open the luggage lock without destruction, the piece of luggage may ultimately also be individually identified by the identification device of a luggage lock connected to a piece of luggage, said identification device providing a lock identification code that is individually associated with the luggage lock. This may—independently of the possibility of storing an opening code in a database of a security institution—for example also be used during luggage tracking in that the identification device may, for example, be read when the piece of luggage arrives at a destination airport and information may be generated about the fact that the piece of luggage identified by the lock identification code was detected at the airport at a certain point in time.

Furthermore, the lock identification code may, for example, also be detected during baggage handling. In this regard, the configuration of the luggage lock with an identification device may also generally enable a tracking of a piece of luggage, whereby the locating of any pieces of luggage lost during a journey may, for example, be facilitated. To that effect, provision may, for example, also be made to read the lock identification code, which may for this purpose, for example, be provided by an RFID tag, at exits of an airport to be able to determine that the piece of luggage has left the airport and to be able to use this information, for example, to clear up a theft or to locate a piece of luggage that has been taken along by mistake.

In this regard, the present disclosure also independently relates to a piece of luggage having a luggage lock that has a contactlessly machine-readable identification device that provides a lock identification code that is individually associated with the luggage lock and/or the piece of luggage. The lock identification code may, for example, be provided in an optically readable form or in a form readable via a radio connection to enable a tracking of the piece of luggage and a contactless machine reading. Furthermore, such a luggage lock may generally be configured with a mechanical and/or electromechanical locking mechanism.

The present disclosure further relates to a method of providing an opening code for a security institution for opening an electronic luggage lock, in particular an electronic luggage lock of the kind described herein and/or an electronic luggage lock of a piece of luggage of the kind described herein.

The method comprises the steps:
transmitting a lock identification code of the luggage lock to a database, and
transmitting the associated opening code to the database.

As already explained, a data pair of a lock identification code and an associated opening code may thus be transmitted to a database that may in particular be readable by the security institution. This may enable employees of the security institution, by identifying the luggage lock based on the lock identification code, to query the associated opening code from the database to be able to open the luggage lock and/or a piece of luggage without destruction during a required check.

For example, the transmission of the lock identification code and the associated opening code may already be carried out by the manufacturer in that the opening code may generally be made available to the security institutions by manufacturers of such luggage locks. However, an owner of the luggage lock may, for example, selectively activate or deactivate such an opening code or define a release period during which the luggage lock may be opened by transmitting the opening code, as already explained above. The owner of the luggage lock may thereby, even with generally stored opening codes, exercise control over the times at which an opening of the luggage lock by third parties, and in particular employees of the security institution, is made possible. Alternatively thereto, provision may, however, also be made that the owner of the luggage lock generates the opening code himself/herself as a release code, which is or will be stored in a memory of the luggage lock, or reads it from the memory and transmits it to the database together with the lock identification code. In such a procedure, the security institutions may thus generally not be granted any access to the luggage lock, but rather only when the owner deliberately transmits an appropriate opening code to the database.

The method described below, however, in particular relates to steps that may be performed by the owner of the luggage lock and/or the piece of luggage.

In some embodiments, the lock identification code and the opening code may be transmitted to a database readable by the security institution. The lock identification code and the opening code may in particular be transmitted to a database readable by a security institution with the duty of performing baggage checks at airports. In this regard, the transmission of the opening code may in particular enable employees of such security institutions to open the luggage lock and/or the piece of luggage without destruction to be able to perform checks at the piece of luggage.

In some embodiments, the lock identification code and the opening code may be transmitted to the database by a mobile opening device, in particular a smartphone, via a wireless connection. An owner of the luggage lock may in particular transmit the lock identification code and the opening code to the database by a mobile opening device, and in particular a smartphone via a corresponding app, to allow the security institutions to open the luggage lock. Alternatively thereto, provision may, however, generally also be made that the lock identification code and the opening code are already stored in the database by the lock manufacturer or that the owner of the luggage lock transmits the lock identification code and the opening code to the database via another channel, for example, in that the owner enters the data pair via an internet website.

In some embodiments, the lock identification code may be wirelessly read from an identification device of the luggage lock and/or from a memory of the opening device by the opening device before the transmission to the database.

For example, provision may be made that the owner of the luggage lock scans an optically readable lock identification code by an opening device, in particular a smartphone, and reads a release code stored in a memory of the luggage lock or of the opening device as an opening code in order to transmit the determined data pair of the lock identification code and the opening code to the database.

Furthermore, different luggage locks or their lock identification codes may, for example, be stored in a memory of the opening device so that an owner of the luggage lock may, for example, select the appropriate lock in an app before the transmission to the database.

The lock identification code may therefore be selected at the opening device in some embodiments. For this purpose, various luggage locks and/or pieces of luggage of the owner may, for example, be displayed in a drop-down menu and may be selectable for a transmission of the associated lock identification code to the database.

In some embodiments, the opening code may be transmitted to the luggage lock via a wireless connection and may be stored as a release code in a memory of the luggage lock. For example, provision may thus be made to generate an opening code to be transmitted to the database by the mobile opening device and then to store it in a memory of the luggage lock as a release code in order thereby to enable an opening of the luggage lock by transmitting the opening code. This storage of the release code may in particular take place by the code change command already explained in connection with the luggage lock and/or such a release code may already be stored in the memory of the luggage lock by the manufacturer. Furthermore, as likewise already explained, information about a release period may alternatively or additionally also be transmitted to the memory of the lock and/or the database.

The opening code may be activated in some embodiments. For this purpose, information about the activation may in particular be transmitted to the luggage lock to enable an opening of the luggage lock by transmitting the opening code. Furthermore, information about the activation may also be transmitted to the database so that the database may include information about whether a stored opening code is currently activated and therefore enables an opening of the luggage lock or not. The owner may thereby define time periods during which the security institutions are allowed to open the luggage lock. In some embodiments, the opening code may therefore also be deactivated, for example after a journey has been completed or the piece of luggage has been received.

In some embodiments, information about a release period during which the luggage lock is to be opened by transmitting the opening code may be transmitted to the luggage lock and/or the database. Thus, the time period for which the luggage lock may be opened by transmitting the opening code may in particular be defined. By transmitting the release period to the database, it may, for example, be achieved that in response to possible requests for the opening code, the opening code is only transmitted during the release period, whereas, by transmitting the information about the release period to the luggage lock, it may furthermore be achieved that a control device of the luggage lock may itself check whether an opening code was detected within the release period in order to allow an opening of the luggage lock only during the release period.

In some embodiments, the opening code may be deleted after the release period has elapsed. The opening code may in particular be deleted from the memory of the luggage lock and/or the database after the release period has elapsed.

It may in particular be ensured by such a deletion of the opening code that the luggage lock may no longer be opened by persons other than the owner of the luggage lock after the release period has elapsed, even in the event of unauthorized access to the database. However, before the start of a journey, the owner of the luggage lock may selectively transmit the lock identification code, an opening code, and information about a release period to the database and/or store this information in the memory of the luggage lock in order to allow the security institutions to open the luggage lock again for this release period.

The release period may be subsequently extendable in some embodiments. This may in particular enable an owner of the luggage lock to extend an already stored release period if a journey is delayed and the security institutions should therefore be allowed to open the luggage lock for a longer time period—until the journey is completed. It may hereby in particular be prevented that a stored opening code already expires before the completion of the journey due to a delayed journey and the luggage lock has to be broken open by the security institutions in the event that a check of the piece of luggage is required at the end of the journey.

In some embodiments, information about the elapse of the release period may be received before the release period elapses. Such information may in particular be received as an alarm message at an opening device of the owner so that the owner may, if necessary, extend the release period if the security institutions are to be allowed access to the piece of luggage for an extended time period. For example, such information may generally be transmitted before the release period elapses or only at the instigation of a security institution or an airline if it is detected that a journey of the owner of the luggage lock is delayed.

In some embodiments, information about a travel route, in particular an origin airport, a destination airport, a stopover, an airline and/or a flight number, may be transmitted to the database. In this regard, information about the travel route along which the luggage lock and/or the piece of luggage will be taken along may be communicated before the start of a journey in order, for example, to enable the security institution to provide employees stationed along this travel route access to the opening code. The group of persons who may generally have access to the luggage lock may hereby in particular be restricted to facilitate the tracing of opening attempts and also to limit the possibilities of gaining access to luggage locks with stored opening codes through the theft of an opening device of the security institution in comparison with a release of the opening code for all the employees of the security institution. The information about the travel route may, for example, be transmitted by the owner, via the opening device and/or an internet website, before the start of a journey, wherein provision may also be made that the information is transmitted to the database by the respective airline after the check-in. For this purpose, the lock identification code may, for example, also be readable by employees of the airline so that a data pair of the lock identification code and a flight number may, for example, be transmitted to the database readable by the security institution in the course of the check-in. However, employees of an airline may possibly only be allowed to transmit data to the database, but not to read the database.

The present disclosure further relates to a method of opening an electronic luggage lock having a readable identification device by a security institution, in particular a luggage lock of the kind described herein and/or an electronic luggage lock of a piece of luggage of the kind described herein, in particular by an opening code provided in accordance with any one of the methods explained above.

The method comprises the steps:
reading a lock identification code of a luggage lock from the identification device,
transmitting the lock identification code of the lock by a mobile opening device of the security institution to a database and requesting an associated opening code, and
receiving the opening code from the database and transmitting the received opening code to the luggage lock by the mobile opening device.

These method steps may in particular be performed by an employee of a security institution to be able to open an electronic luggage lock without destruction when a check of a piece of luggage secured by the electronic luggage lock is required. The reading of the lock identification code of the luggage lock from the identification device may further in particular take place by the mobile opening device of the security institution, and in particular a smartphone, by which the lock identification code is also transmitted to the database. For example, an employee of the security institution may for this purpose read an optically and/or a wirelessly electronically detectable lock identification code from the identification device of the luggage lock by the opening device and may transmit it to the database of the security institution in order to request the associated opening code for opening the electronic luggage lock. Alternatively thereto, provision may, however, generally also be made to enter a lock identification code manually at the opening device, for example by entering a numerical sequence visible at the luggage lock, to then transmit the lock identification code to the database by the opening device.

As a result of the request for the associated opening code, it may be checked by the transmitted lock identification code whether the associated opening code is stored in the database and the opening code may, if necessary, be transmitted to the employee of the security institution or his/her opening device. The opening code may then be transmitted by the employee of the security institution by the opening device to the electronic luggage lock and in particular to a code receiving device of the electronic luggage lock so that a control device of the electronic luggage lock may compare the received opening code with a release code stored in a memory of the electronic luggage lock and may control an electromechanical locking mechanism to release a securing section of a piece of luggage or to open the luggage lock if the received opening code matches the stored release code.

The method steps explained below may in particular be performed by employees of the security institution.

In some embodiments, the database may be readable by the security institution, in particular readable by a security institution with the duty of performing baggage checks at airports. In particular, employees tasked with checking pieces of luggage may thus read lock identification codes of luggage locks and request associated opening codes to be able to open the respective electronic luggage locks without destruction.

The request for the opening code may be documented in the database in some embodiments. The security institutions may in particular thereby document whether a specific piece of luggage has been checked and/or the associated luggage lock has been opened. Such a documentation may, for example, make it possible to provide proof of one's own work to an internal or external controlling, wherein it may furthermore, for example, be traced whether an unauthorized opening has taken place after a piece of luggage was handed in if, for example, a query of the opening code has taken place that may, however, not be associated with any check that has actually taken place and/or with any employee of the security institution.

In some embodiments, a point in time of the request for the opening code, a location of the request for the opening code, a device identification of the mobile opening device and/or a person identification of a requesting user may be documented in the database. In particular, it may thus be documented which employee of the security institution requested an opening code for opening a specific luggage lock or by which opening device an opening attempt took place. If necessary, it may thus also be traced if the opening code was requested by a stolen opening device of the security institution and by an unauthorized person in this regard.

In some embodiments, a request authorization may be assigned to a plurality of mobile opening devices and/or persons and the opening code may only be transmitted if the opening code is requested by an authorized person and/or an authorized device.

For example, a user identification and/or device identification may be transmitted to the database with the request for the opening code so that it may be checked whether the requesting user or device has been assigned a request authorization. Such an assignment of request authorizations may in particular enable a security institution to provide an opening code for opening a respective luggage lock only to a selection of employees, for example to employees who are stationed along a travel route of an owner of the piece of luggage previously transmitted to the database. Furthermore, provision may be made to only assign a request authorization to individual employees. By assigning request authorizations to only a limited group of employees, the risk may in particular be reduced that unauthorized persons may gain access to opening codes of a plurality of luggage locks by stealing an opening device of the security institution. In general, however, a request authorization may also be granted to all the employees of a security institution.

In some embodiments, the request authorization may further be checked by a legitimation check and/or identity check in that the opening code may, for example, only be transmitted after a password is entered at the mobile opening device or an identity is proven at the mobile opening device, for example by matching a fingerprint or by a facial recognition.

In some embodiments, the request authorization may be assigned in dependence on information about a travel route of the piece of luggage, said information being stored in the database and being associated with the lock identification code. Employees of the security institution who are stationed along a travel route that is stored in the database and associated with the lock identification code of the luggage lock and/or the opening devices of said employees may in particular be assigned a request authorization.

In some embodiments, the assignment of the request authorization may be able to be requested by the opening device. This may in particular enable an employee of the security institution who would like to open the luggage lock but does not yet have a request authorization to request the request authorization in order to nevertheless be able to open the luggage lock without destruction and perform the check of the piece of luggage. For example, the requesting of the request authorization may take place by a smartphone via an app. Furthermore, provision may also be made to generally only grant a request authorization after it has been requested so that the opening code is only made available to those employees of the security institution who actually want to perform a check of the respective piece of luggage. The assignment of the request authorization in response to a request for the request authorization may in particular also take place by directly transmitting the opening code.

In some embodiments, after the identification device has been read, information about a point in time of a previous request for the opening code may be displayed at the opening device.

In addition thereto, information about a location from which the previous request was made may in particular also be displayed at the opening device. This information may, for example directly after the reading of the identification device or after the request for the opening code, be transmitted, possibly together with the opening code, to the opening device and be displayed there so that, for example, an employee of the security institution may be informed whether a check has already been performed at the airport at which the piece of luggage is currently located. As a result of this information, unnecessary multiple checks at a location or an airport may possibly be avoided.

In some embodiments, an opening of the luggage lock may be enabled or effected by transmitting the received opening code to the luggage lock, wherein the opening may be documented in a memory of the luggage lock.

In particular, by reading the memory, the owner of the luggage lock thus trace whether the luggage lock was opened while the owner did not have access to the piece of luggage or the luggage lock. Furthermore, the location, the time and/or a device identification of the opening device by which the luggage lock was opened may, for example, also be documented in the memory. In some embodiments, a person identification of the opening user may furthermore be documented in the memory of the luggage lock.

This documentation in the memory of the luggage lock may in particular take place in addition to a documentation in the database so that both the owner of the luggage lock, by reading the memory of the luggage lock, and the security institution, by reading the database, may independently track opening attempts by employees of the security institution. Due to the additional storage of opening attempts in the memory of the luggage lock, it may in particular be ensured for the owner of the luggage lock that opening attempts after a piece of luggage has been handed in may also be detected if a possible manipulation of the database of the security institution takes place. This may in particular enable an owner of a piece of luggage to exonerate himself/herself from the unjustified suspicion of having already originally carried a prohibited substance or a prohibited item found in the piece of luggage, even if no opening attempt was registered in the database of the security institution due to a manipulation.

In some embodiments, the opening code may only be transmitted from the database to the mobile opening device if the request for the opening code is received during a release period stored in the database. As already explained, an owner of the luggage lock may thereby be given the control to allow an opening of the luggage lock by employees of the security institution only during a defined release period, whereas the luggage lock may only be opened by the authorized owner outside the release period.

In some embodiments, before the release period elapses, a request for extending the release period may be transmitted from the database to a mobile opening device of an owner of the piece of luggage by which the lock identification code and/or the opening code has/have been provided. In particular, the owner of the luggage lock and/or the piece of luggage may thus be notified before the release period elapses that the release period is ending so that the owner may subsequently extend the release period, for example if a journey is delayed. The owner may hereby ensure that employees of the security institution may open the luggage lock without destruction despite the delay in the journey and that a destruction of the luggage lock is not required during a check after the original release period has elapsed. Furthermore, provision may generally be made to inform the owner about a request for the opening code outside the release period so that the owner may set a new release period, if necessary, and enable a check by the requesting employee of the security institution.

The present disclosure further relates to a method of opening an electronic luggage lock comprising a readable identification device by a security institution, in particular an electronic luggage lock of the kind disclosed herein and/or an electronic luggage lock of a piece of luggage of the kind disclosed herein, wherein the electronic luggage lock may in particular be opened by an opening code provided in accordance with a method of providing an opening code of the kind disclosed herein.

The method comprises the steps:
receiving a plurality of opening codes and associated lock identification codes of a respective luggage lock at a database,
storing the plurality of opening codes and associated lock identification codes, or a selection thereof, on a mobile opening device of the security institution,
reading a lock identification code of the luggage lock from the identification device,
retrieving the opening code associated with the read lock identification code from the stored opening codes,
transmitting the retrieved opening code to the luggage lock by the mobile opening device.

In this method, provision may thus be made that a plurality of data pairs of opening codes and respective associated lock identification codes received from owners of respective luggage locks at a central database of a security institution are transferred to opening devices of the security institution and are locally stored at the opening devices. For this purpose, the opening devices may in particular have memory, for example a semiconductor memory and/or an EEPRON, in which the opening codes and the associated lock identification codes may be stored.

Provision may in particular be made to transmit the received data pairs to opening devices and to store them on opening devices that are suitable for performing a check. For example, received opening codes for which information about a travel route has also been stored may be stored together with the respective lock identification codes on opening devices of employees of the security institution who are stationed along the travel route so that, in some embodiments, a selection of the data pairs of opening codes and associated lock identification codes received at the database may be stored on the opening device of the security institution in dependence on information about a travel route stored in the database. Furthermore, opening codes for which information about a release period and/or a travel period has been received at the database may, for example, be stored on mobile opening devices of the security institution for a time period corresponding to the release period and/or the travel period. Furthermore, opening codes with associated lock identification codes that are, for example, intended for a specific time period, for example opening codes that are intended for a specific day or a specific week, may be transmitted to mobile opening devices of the security institution and stored locally there. Whether a specific opening code received at the database is intended for a specific time period or whether a check is possible during the specific time period may, for example, again be checked based on information about a release period and/or a travel period possibly additionally received at the database. In general, however, all the data pairs of opening codes and associated lock identification codes received at the database may also be stored on all the opening devices of the security institution, in particular all the data pairs of opening codes and associated lock identification codes which are received at the database and for which no further information, for instance information on a travel route, has been stored.

For example, provision may be made that the data pairs of opening codes and associated lock identification codes are retrieved from the database and transferred to the opening device when a program or an app is started on the opening device. To be able to transmit only a selection of opening codes and associated lock identification codes that is matched with the respective opening device to the opening device, device information and/or location information may be transmitted from the opening device to the database, for example on a coupling of the opening device to the database. For example, depending on information about a travel route, a travel period and/or a release period, a selection of data pairs of opening codes and associated lock identification codes may then be selected for a transfer to the opening device and stored on the opening device.

The starting of the program or the app may furthermore require a legitimation check and/or identity check so that it may, for instance, be ensured by a password entry and/or a biometric identity check that opening codes are only transferred to those opening devices that are in the possession of an authorized employee of the security institution.

Furthermore, provision may alternatively or additionally be made that the opening codes and associated lock identification codes may be retrieved from the database and stored on the opening device by an update command that may be triggered at an opening device. It may in particular hereby be achieved that the opening codes and lock identification codes stored on the opening device are always up to date so that, for example, data pairs that are only transmitted to the database in the course of a day may also be transferred to the opening device. Such an update command may, for example, be triggered on occasion—for instance between consecutive checks—and/or before an upcoming check by an employee of the security institution to be able to call up a current selection of opening codes stored in the database on the opening device for the upcoming check. Such an update command may also require a legitimation check and/or identity check to ensure that only authorized employees of the security institution may retrieve data from the database. For example, the update command may be triggered by a swipe motion on a touchscreen of the opening device or by actuating a provided button.

Furthermore, the opening codes and the associated lock identification codes, or the selection thereof, may be transferred to the opening devices of the security institution at predetermined times in that, for instance, an update of the opening codes and lock identification codes stored on the opening devices of the security institution may always be performed before the start of a shift and/or at a predetermined time.

Since data pairs of opening codes and associated lock identification codes may thus be transmitted directly to the opening device, in particular the opening devices, of the security institution and stored on the opening device or the opening devices, an associated opening code may be directly retrieved in the course of a check of a piece of luggage after the reading of the lock identification code of a luggage lock to be opened without destruction and may, for example, be read from a memory of the opening device in which the opening code associated with the read lock identification code may be stored. An employee of the security institution may then open the luggage lock by transmitting the retrieved opening code, for example to a code receiving device of the luggage lock, and may thus perform the check without a communication with the central database of the security institution being required. In particular, a radio connection to the database is therefore not necessarily required during the checks and the check may possibly also be performed in the case of a possible disturbance of such a connection without the luggage lock having to be destroyed.

However, also with such a direct storage of opening codes on the opening device, it is possible after the reading of a lock identification code for which no associated opening code is stored on the opening device, to request the associated opening code at the central database. For this purpose, the opening code associated with the read lock identification code may, for example, be specifically requested at the database and transmitted to the opening device if the opening code is stored in the database and/or a request authorization is present, or the update command already mentioned may be triggered in order to transfer the opening codes currently stored in the database, or a selection thereof, to the opening device and, at most, to then have to destroy the luggage lock if no opening code has actually been stored in the database. In particular, due to the possibility of also being able to directly request an opening code associated with a read lock identification code, errors in the selection of opening codes and associated lock identification codes to be transmitted to the opening device may, for example, be compensated or a check may be made possible for a piece of luggage which is guided on a travel route that deviates from a travel route stored in the database and for which no opening code has been assigned to an employee stationed along the deviating travel route.

In some embodiments, an opening of the luggage lock may be enabled or effected by transmitting the received opening code to the luggage lock and the opening may be documented in a memory of the luggage lock. Once again, an owner of a luggage lock that was opened in the course of a check by an employee of a security institution may thus be offered a possibility to be able to trace or prove such opening processes. In addition to information that an opening process has taken place, information about a point in time of the opening, a location of the opening, a device identification of the mobile opening device by which the opening code was transmitted, and/or a person identification of the employee may, for example, also be documented in the memory.

The plurality of opening codes and associated lock identification codes may also be associated with a respective release period in some embodiments. As already explained, in addition to the data pair of the lock identification code and the associated opening code, an owner of a luggage lock may, for example, also transmit information to the database about a release period for which the luggage lock may be opened by transmitting the stored opening code. This release period may, for example, be considered when storing on the opening devices in that, for instance during an update, only those opening codes with associated lock identification codes are transferred to the opening devices, and stored there, that are associated with a release period that lies in the future and/or a release period that lies in a predetermined time period, for instance a time period between two scheduled updates. Furthermore, in some embodiments, in addition to the data pair of the lock identification code and the associated opening code, the information about the release period may also be transmitted to the opening device, wherein the data pair may, for example, be deleted from the opening device after the release period has elapsed. Furthermore, in some embodiments, the data pair may be deleted from the database after the release period has elapsed.

In some embodiments, the reading of the lock identification code of the luggage lock from the identification device and/or the retrieving of the opening code associated with the read lock identification code may be documented in the mobile opening device of the security institution. For example, information about a point in time of the reading, a location of the reading, a device identification of the mobile opening device by which the lock identification code was read, and/or a person identification of an employee may be documented in the mobile opening device of the security institution. The corresponding information may, for example, be written to a memory of the opening device directly after the reading of a lock identification code, wherein alternatively or additionally provision may also be made that the retrieval of the opening code is documented in the opening device. Due to such a documentation, it may in particular be traced whether, by the respective opening device, a lock identification code has been read and/or an associated opening code has been retrieved and the prerequisite for performing a check has thus been provided.

The documentation that took place in the mobile opening device may further be transmitted to the database in some embodiments. For example, a documentation stored in a memory of the mobile opening device may be transmitted to the database on a subsequent coupling to the database, for example in order to update opening codes and associated lock identification codes. In this connection, a device identification of the mobile opening device and/or a person identification of an employee associated with the opening device may in particular also be transmitted to the database so that an association of the documentation with a respective opening device and/or a respective employee may take place. As already explained above, such a central documentation of the security institution in particular makes it possible to check or prove one's own work.

### BRIEF DESCRIPTION OF THE DRAWINGS

The present disclosure will be explained in the following purely by way of example with reference to embodiments and to the drawings.

There are shown:

FIG. 1A is a respective representation of a piece of luggage in an open state, wherein the piece of luggage has an electronic luggage lock which is to be opened without destruction by a security institution and by which the closed state may be secured;

FIG. 1B is a respective representation of the piece of luggage in a closed state, wherein the piece of luggage has the electronic luggage lock which is to be opened without destruction by the security institution and by which the closed state may be secured;

FIG. 2A is a respective representation of a further piece of luggage of this kind, in the open state, comprising an electronic luggage lock;

FIG. 2B is a respective representation of the further piece of luggage of this kind, the closed state, comprising the electronic luggage lock;

FIG. 3A is a respective schematic representation of a first embodiment of the electronic luggage lock for illustrating an electromechanical locking mechanism of the luggage lock by which a securing section of the piece of luggage may be selectively locked or released relative to the luggage lock;

FIG. 3B is another respective schematic representation of the first embodiment of the electronic luggage lock for illustrating the electromechanical locking mechanism of the luggage lock by which the securing section of the piece of luggage may be selectively locked or released relative to the luggage lock;

FIG. 3C is another respective schematic representation of the first embodiment of the electronic luggage lock for illustrating the electromechanical locking mechanism of the luggage lock by which the securing section of the piece of luggage may be selectively locked or released relative to the luggage lock;

FIG. 4A is a respective schematic representation of a further embodiment of the electronic luggage lock and its electromechanical locking mechanism;

FIG. 4B is another respective schematic representation of the further embodiment of the electronic luggage lock and its electromechanical locking mechanism;

FIG. 4C is another respective schematic representation of the further embodiment of the electronic luggage lock and its electromechanical locking mechanism;

FIG. 5A is a respective schematic representation of a further embodiment of the electronic luggage lock and its electromechanical locking mechanism;

FIG. 5B is another respective schematic representation of the further embodiment of the electronic luggage lock and its electromechanical locking mechanism;

FIG. 5C is another respective schematic representation of the further embodiment of the electronic luggage lock and its electromechanical locking mechanism;

FIG. 6A is a respective schematic representation of another further embodiment of the electronic luggage lock and its electromechanical locking mechanism;

FIG. 6B is another respective schematic representation of the further embodiment of the electronic luggage lock and its electromechanical locking mechanism;

FIG. 6C is another respective schematic representation of the further embodiment of the electronic luggage lock and its electromechanical locking mechanism;

FIG. 7 a schematic representation of a control device of the electromechanical luggage lock and devices for controlling the electromechanical locking mechanism that are connected to the control device;

FIG. 8A is a representation of the piece of luggage comprising the electronic luggage lock and of a mobile opening device of the owner of the piece of luggage;

FIG. 8B is a schematic representation for illustrating methods of providing an opening code of the electronic luggage lock for a security institution;

FIG. 8C is another schematic representation for illustrating methods of providing the opening code of the electronic luggage lock for the security institution;

FIG. 9A is a representation of the piece of luggage comprising the electronic luggage lock and of a mobile opening device of the security institution;

FIG. 9B is a schematic representation for illustrating methods of opening the electronic luggage lock by the security institution;

FIG. 9C is another schematic representation for illustrating methods of opening the electronic luggage lock by the security institution;

FIG. 10A is a respective schematic representation of a further embodiment of an electronic luggage lock for locking a securing section of a piece of luggage relative to the luggage lock, wherein the luggage lock may be released from the piece of luggage; and

FIG. 10B is another respective schematic representation of the further embodiment of the electronic luggage lock for locking the securing section of a the piece of luggage relative to the luggage lock, wherein the luggage lock may be released from the piece of luggage.

### DETAILED DESCRIPTION

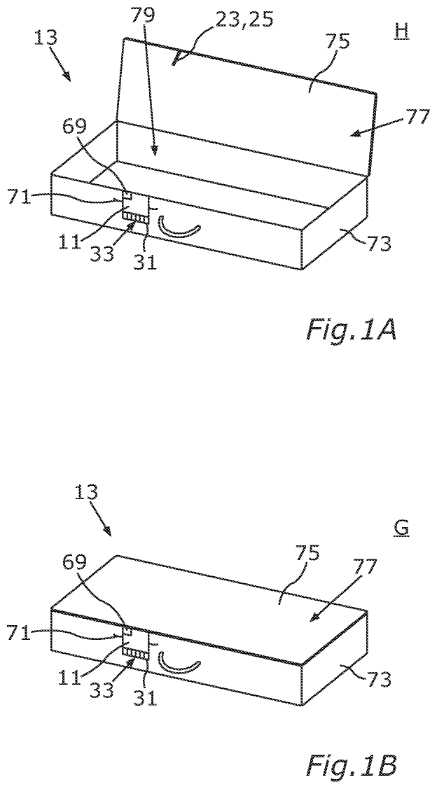

FIG. 1A shows a piece of luggage 13 that has a luggage body 77 that comprises a first container part 73 and a second container part 75. The second container part 75 is pivotable relative to the first container part 73 between an open position H shown in FIG. 1A, in which the second container part 75 enables access to an inner space 79 of the luggage body 77, and a closed position G shown in FIG. 1B in which access to the inner space 79 is blocked.

Furthermore, a securing section 23 of the piece of luggage 13 is formed at the second container part 75 that—by an electronic luggage lock 11 that is arranged at the first container part 73—may be selectively locked relative to the luggage lock 11 when the second container part 75 is in the closed position G. Due to this locking of the securing section 23, the second container part 75 may also be locked relative to the luggage lock 11, and thus relative to the first container part 73, in the closed position G to secure a closed state of the piece of luggage 13. To be able to connect the electronic lock 11 to the first container part 73, the electronic luggage lock 11 has a fastening device 71.

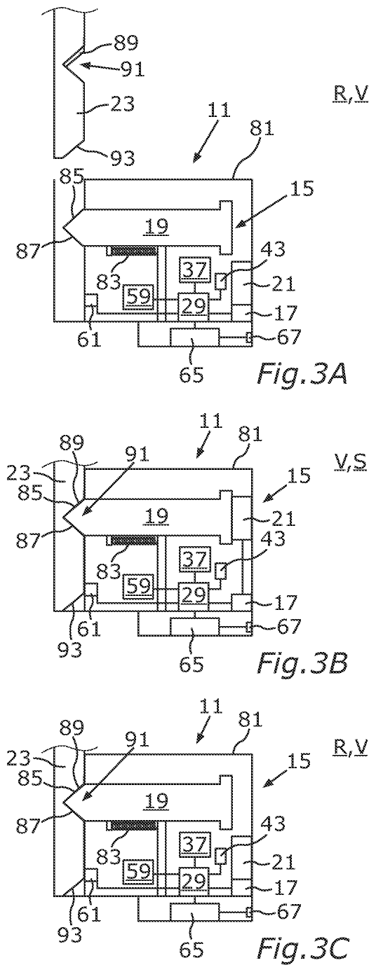

In the piece of luggage 13 illustrated by FIGS. 1A and 1B, the securing section 23 is formed by way of example as a bolt that projects from the second container part 75 and that furthermore forms a closure 25 of the piece of luggage 13 to also be able to keep the second container part 75 in the closed position G independently of a locking, as will be further explained below. However, the non-locked securing section 23 is released for a movement relative to the luggage lock 11 so that the closure 25 may be manually opened. Therefore, a locking of the securing section 23 by the electronic luggage lock 11 or an electronic locking mechanism 15 of the electronic luggage lock 11 is required to lock the securing section 23 relative to the electronic luggage lock 11 and to secure the second container part 75 in the closed position to the first container part 73 (cf. also FIGS. 3A to 6C).

FIGS. 3A to 3C schematically illustrate a first embodiment of the electromechanical lock 11 and its electromechanical locking mechanism 15 by which the securing section 23 of the piece of luggage 13 may be selectively locked or released relative to the luggage lock 11.

As FIG. 3A shows, the illustrated electromechanical locking mechanism 15 has a securing element 19 that is preloaded in the direction of a locking position V by a spring 83. Furthermore, the electromechanical locking mechanism 15 comprises an actuator 17, for example an electric motor, and a latch 21 that is movable by the actuator 17 between a release position R, in which the securing element 19 is released for a movement against the preload of the spring 83, and a blocking position S in which such a movement of the securing element 19 is blocked. To be able to actuate the actuator 17 and move the latch 21, a control device 29 is further provided.

In FIG. 3A, the securing element 19 is shown in the locking position V while the latch 21 is positioned in the release position R. In this position, the securing section 23 of the piece of luggage 13 may be introduced into a lock environment 81 of the luggage lock 11, wherein the securing element 19 may be urged back against the force of the spring 83 by the cooperation of a slope 93 of the securing section 23 with a slope 85 of the securing element 19 to enable the introduction of the securing section 83. As soon as the securing section 23 is fully introduced, the securing element 19 enters into engagement with an engagement opening 91 formed at the securing section 23 due to the preload, whereby the securing section 23 acting as a luggage closure 25 is already held at the luggage lock 11 but is released for a movement relative to the luggage lock 11. This can be seen from FIG. 3C, wherein, on a manual removal of the securing section 23 from the lock environment 81, the securing element 19 may again be urged back against the force of the spring 83 by the cooperation of the slopes 85 and 89.

However, to be able to lock the securing section 23 relative to the luggage lock 11, the latch 21 may, as FIG. 3B shows, be moved into the blocking position S in which a movement of the securing element 19 against the force of the spring 83 is blocked so that the securing section 23 may not be released from the lock environment 81. Since the securing section 23 may further be connected to the second container part 75 of the luggage body 77 of the piece of luggage 23, a relative movement between the second container part 75 and the first container part 73 may also be prevented by this locking of the securing section 23. The movement of the latch 21 into the blocking position S may, for example, take place as a result of a locking command that is in particular wirelessly received from the control device 29.

Alternatively thereto, an electromechanical locking mechanism 15 configured in this manner may, due to the preload of the securing element 19, however, in particular provide an automatic function by which the securing section 23 may automatically be locked after an introduction into the lock environment 81. For this purpose, the electronic luggage lock 11 in particular has a sensor 61 that is configured to detect the introduced securing section 23 and to determine a corresponding detection signal to the control device 29, whereupon the control device 29 may control the actuator 17 to move the latch 21 into the blocking position S.

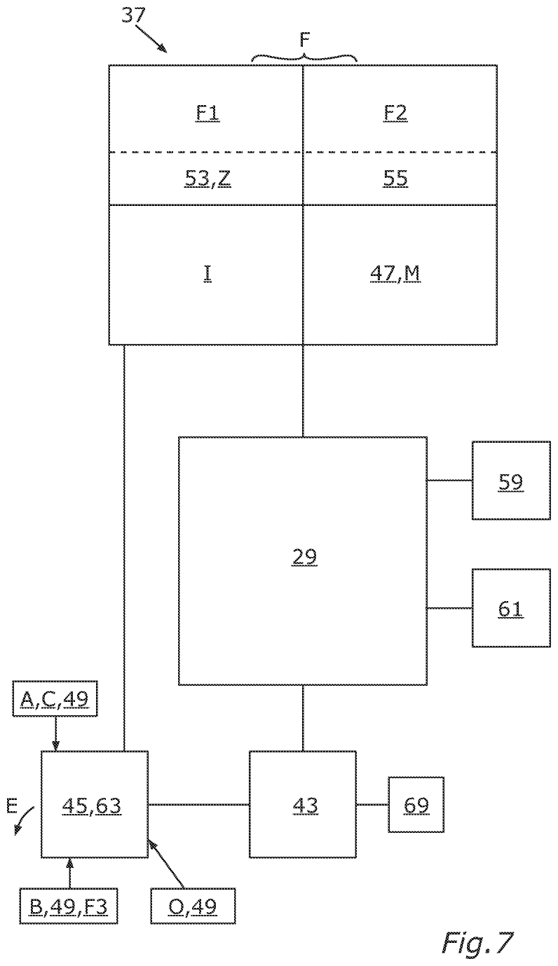

However, to be able to selectively release the locked securing section 23 and open the piece of luggage 13, the control device 29 is connected to a memory 37 in which a release code F is stored (cf. also FIG. 7). Furthermore, the control device 29 is connected to a code receiving device 43 that is configured to receive an opening code O from a mobile opening device 35, for example a smartphone of the owner of the luggage lock 11, via a wireless connection (cf. also FIG. 7 and FIGS. 8A and 9A). The control device 29 is configured to compare the received opening code O with the release code F stored in the memory 37 and to control the electromechanical locking mechanism 15 to release the securing section 23 if the received opening code O matches the stored release code F.

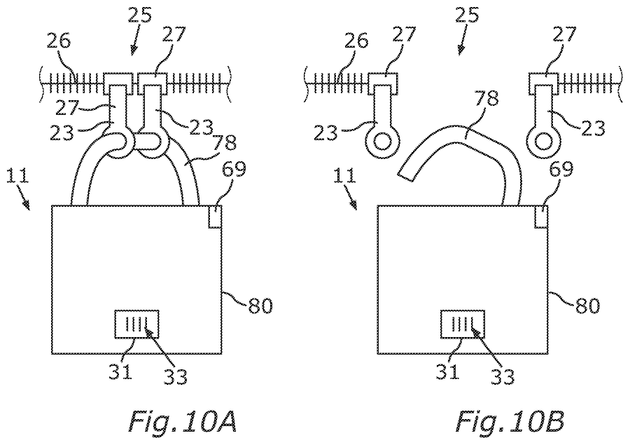

As can be seen from FIG. 7, the code receiving device 43 may in particular be connected to a radio module 45 to receive the opening code O via a wireless connection. In particular, provision may in this respect be made that the code receiving device 43 is configured to receive the opening code O via a Bluetooth or an NFC (Near Field Communication) connection so that the controlling of the locking mechanism 15 to release the securing section 23 is only possible by a person located in the immediate vicinity of the luggage lock 11 and his/her opening device 35, whereas a remote opening of the luggage lock 11 is not possible. Furthermore, a button 69 is provided at the luggage lock 11, wherein an energy supply of the code receiving device 43 may be activated by actuating the button 69 and the code receiving device 43 may be woken up from an energy-saving sleep mode before the opening code O is transmitted (cf. FIGS. 1A, 1B, 10A and 10B).

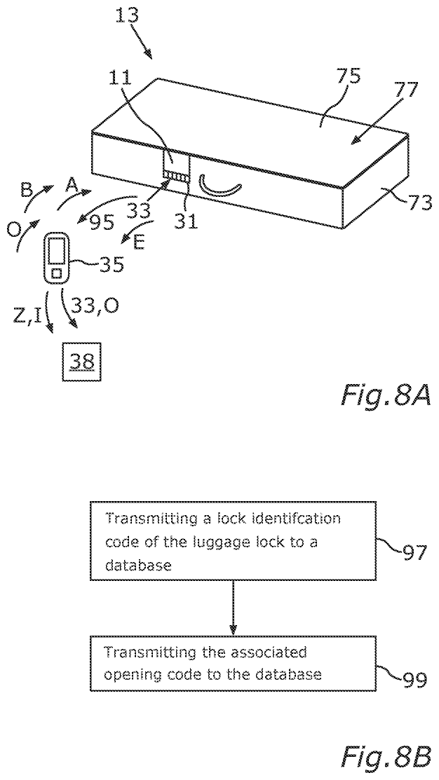

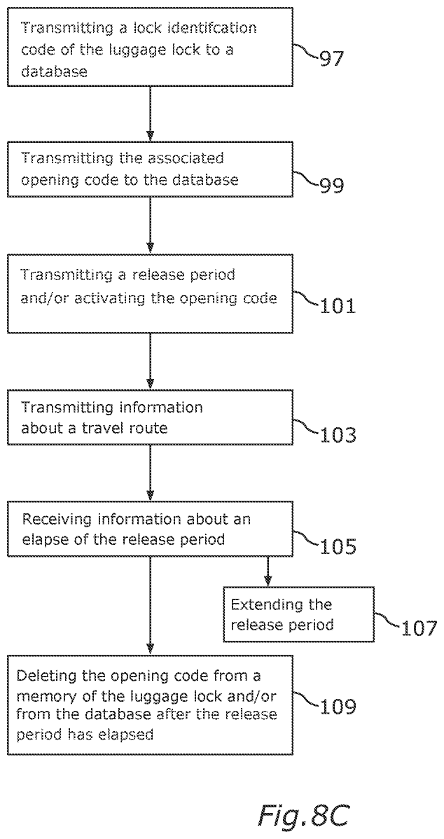

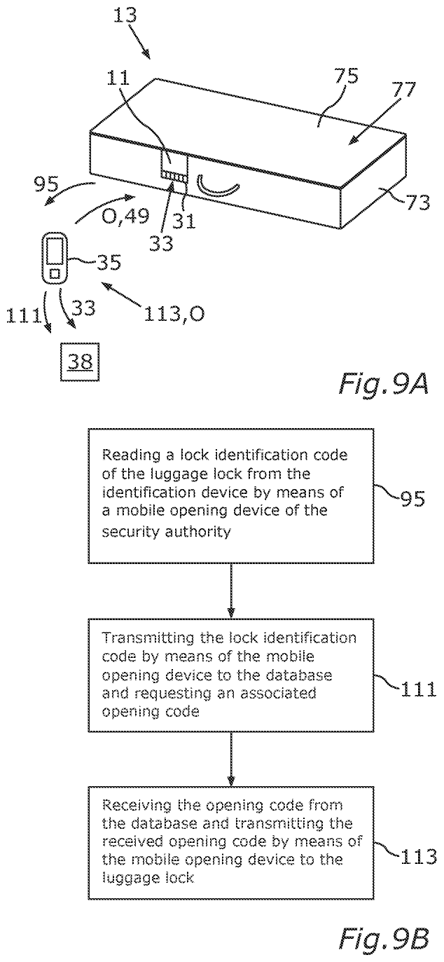

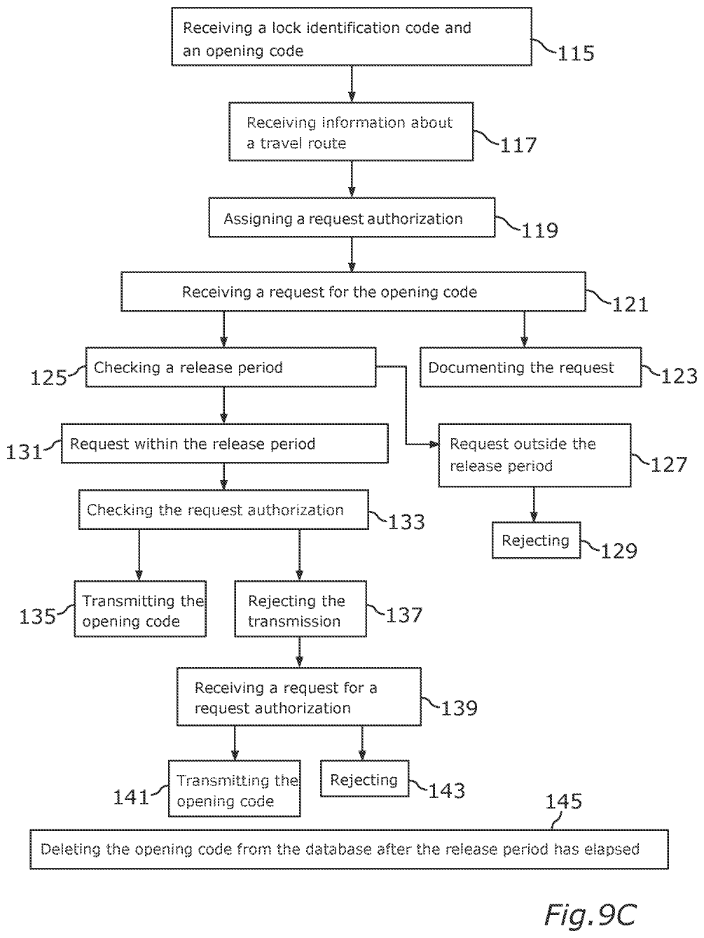

FIGS. 3A to 3C further show that the control device 29 is connected to an energy source 65 via which the control device 29 and/or the electromechanical locking mechanism 15 may be supplied with electrical energy. Furthermore, a charging socket 67 is, however, provided via which, in particular when the internal energy source 75 is exhausted, electrical energy may be provided from an external energy source and, for example, the mobile opening devices 35 shown in FIGS. 8A and 9A to be able to nevertheless actuate the electromechanical locking mechanism 15. The control device 29 may furthermore be configured to send an energy source state signal E to the opening device of the owner 35 of the luggage lock 11 to alert the owner to a near exhausted state of the energy source 65 so that the owner may replace or charge the energy source 65. This may particular take place via the radio module 45 and, for example, a mobile radio connection and/or a WLAN/WiFi connection.

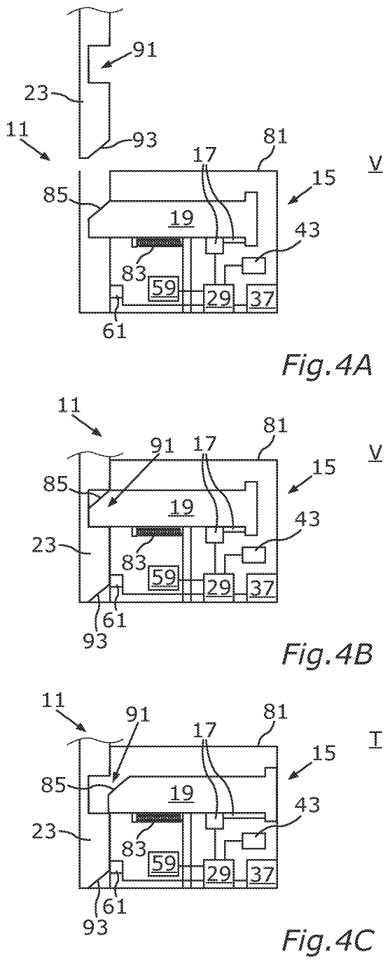

FIGS. 4A to 4C illustrate a further embodiment of the electromechanical luggage lock 11 or an electromechanical locking mechanism 15, wherein the energy source 65 and the charging socket 67 are, however, not shown. Also in this embodiment, a securing element 19 preloaded in the direction of a locking position V is provided that may be urged back by introducing the securing section 23 into the lock environment 81 and that enters into engagement with the securing section 23 when the latter is completely introduced into the lock environment 81. However, unlike in the embodiment illustrated by FIGS. 3A to 3C, the engagement opening 91 formed at the securing section 23 is, however, formed without slopes and the securing element 19 also has only one slope 85 to be urged back during the introduction of the securing section 23 so that the securing section 23 is locked directly relative to the luggage lock 11 after the introduction into the lock environment 81. However, to be able to selectively release the securing section 23, the actuator 17 in this embodiment is configured to drive the securing element 19, in response to an unlocking command received from the control device 29 or the received opening code O, against the force of the spring 83 into an unlocking position T in which the securing element 19 is out of engagement with the engagement opening 91 of the securing section 23 and the securing section 23 is released for a movement relative to the luggage lock 11 (cf. FIG. 4C). This release may in particular take place when an opening code O corresponding to the one in the memory 37 is received at the code receiving device 43.

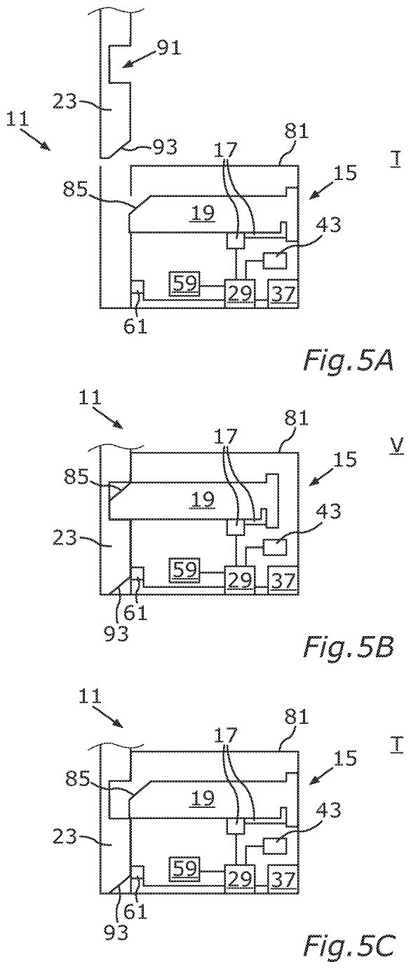

In the embodiment of the electromechanical luggage lock 11 or its electromechanical locking mechanism 15 illustrated by FIGS. 5A to 5C, the securing element 19 is furthermore not preloaded in the direction of a locking position V, but is movable by the actuator 17 between the locking position V and the unlocking position T. Also in such an embodiment, an automatic function may, however, generally be provided in that, for example in response to a signal of the sensor 61 that detects the introduced securing section 23, a command for moving the securing element 19 into the locking position V may be generated immediately. The movement of the securing element 19 into the unlocking position T may also take place in such an embodiment when a corresponding opening code O is received at the code receiving device 43 from a mobile opening device 35.

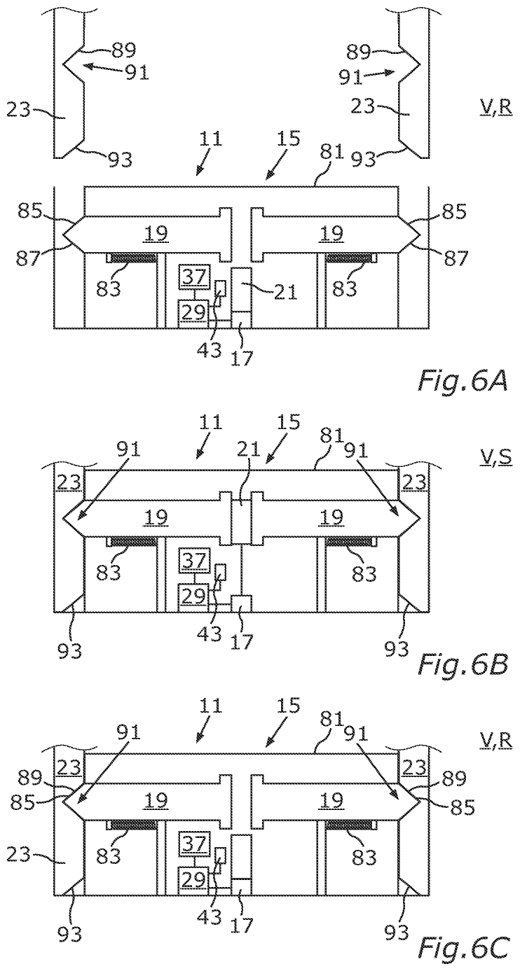

In FIGS. 6A to 6C, an electromechanical locking mechanism 15 that generally corresponds to FIGS. 3A to 3C is shown, wherein this electromechanical locking mechanism 15, however, has two securing elements 19 that are preloaded into a respective locking position V to be able to lock or release two securing sections 23 relative to the luggage lock 11. Here, too, the controlling of the actuator 17 to move the latch 21 may in particular take place based on signals of respective sensors 61 for detecting the securing sections 23, wherein these sensors 61 are, however, not shown in FIGS. 6A to 6C. Furthermore, provision may be made to provide a respective latch 21 movable between a release position R and a blocking position F for each of the securing elements 19 so that the securing sections 23 may also be individually locked relative to the luggage lock 11. Furthermore, it is generally possible to lock two securing sections 23 by a single securing element 19 by, for example, guiding the securing element 19 through two completely open engagement openings 91.

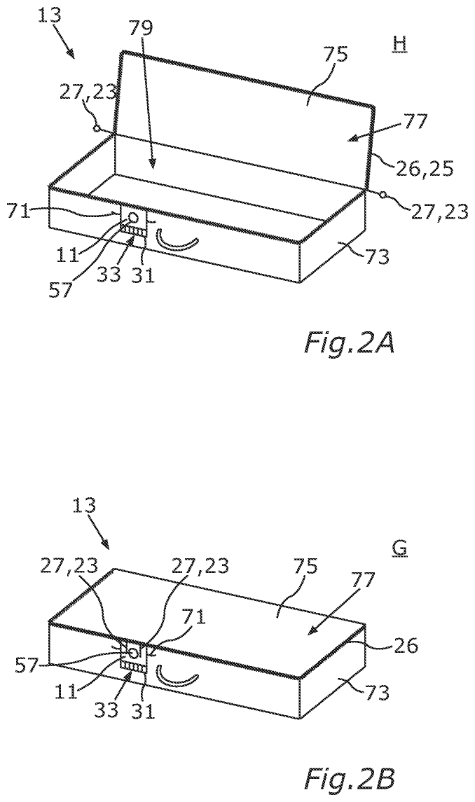

Such an electromechanical locking mechanism 15 for locking two securing sections 23 may, for example, be provided in a luggage lock 11 of a piece of luggage 13 that is illustrated by FIGS. 2A and 2B and that has a luggage closure 25 which is configured as a zipper 26 and via which the first container part 73 and the second container part 75 are connected to one another. The zipper 26 may be selectively closed via two handles 27 in the closed position G of the second container part 75 in order thereby to hold the second container part 75 at the first container part 73 (cf. FIG. 2B). Furthermore, the handles 27 function as securing sections 23 of the piece of luggage 13 and may, for example, be selectively locked relative to the electromechanical luggage lock 11 by the electromechanical locking mechanism 15 illustrated by FIGS. 6A to 6C in order to secure the second container part 75 into the first container part 73. To gain access to the inner space 79 of the luggage body 77, it is therefore necessary to release the handles 27 for a movement relative to the electromechanical luggage lock 11 by transmitting an opening code O corresponding to the one in the memory 37 of the luggage lock 11 so that the handles 27 may be removed from the lock environment 81 of the electronic luggage lock 11 and the zipper 27 may be opened.

In addition to the electromechanical locking mechanism 15, the electronic luggage lock 11 of the piece of luggage 13 illustrated by FIGS. 2A and 2B furthermore has a mechanical locking mechanism 57 of which a lock cylinder to be actuated by a key is shown by way of example. This mechanical locking mechanism 57 may in particular enable an owner of the luggage lock 11 to actuate the locked securing section 23 by actuating the mechanical locking mechanism 57 while bypassing the electromechanical locking mechanism 15 such that this mechanical locking mechanism 57 may provide a mechanical override of the electromechanical locking mechanism 15. The implementation of such a mechanical override is generally known to the skilled person so that it will not be looked at in any more detail here.

A piece of luggage 13 may furthermore, as a luggage closure 25, in particular also have a buckle closure comprising a buckle via which a first container part may be held at a second container part. For this purpose, the buckle may in particular be connected to one of the container parts to be able to engage behind an engagement strip formed at the other container part. In such luggage closures 25, provision may in particular be made to lock a catch of the buckle by an electromechanical locking mechanism 15 of a luggage lock 11 in order thereby to block a release of the engagement behind of the engagement strip. The luggage lock 11 may therefore in particular be integrated into such a buckle.

Furthermore, luggage locks 11 of the kind described herein may, however, also be releasable from the piece of luggage 13 in that, for example, a luggage lock 11 configured as a padlock having a U-shaped hoop 78 may be used to connect the two handles 27 of the zipper 26 of the piece of luggage 13 illustrated by FIGS. 2A and 2B to one another by the hoop 78 and to lock them relative to the luggage lock 11 by locking the hoop 78 to a lock body 80, as is illustrated by FIGS. 10A and 10B.

Since the luggage locks 11 described above may be opened by mobile opening devices 37 by wirelessly transmitting an opening code O, the owner of such a luggage lock 11 may be provided with a convenient possibility of opening the luggage lock 11 with a reliable locking against unauthorized opening attempts. Furthermore, the luggage locks 11, however, offer the possibility of being opened non-destructively by employees of a security institution who have to perform the checks of the piece of luggage 13 in the absence of the owner so that the contents of the piece of luggage 13 may be checked by authorized persons without having to break open the luggage lock 11 for this purpose.

To make this possible, the electromechanical luggage lock 11 in particular comprises an identification device 31 via which a lock identification code 33 individually associated with the electromechanical luggage lock 11 may be read so that the luggage lock 11 may be identified by reading the identification device 31. The lock identification code 33 may therefore be stored together with the opening code O in a database 38 readable by a security institution so that an employee of the security institution may, during a check, first read the lock identification code 33 and then query the associated opening code O from the database 38 in order to open the luggage lock 11 without destruction by transmitting the opening code O (cf. FIGS. 8A and 9A).

The lock identification code 33 may in particular be optically readable and may, for example, be formed as a one-dimensional or two-dimensional optical code applied by laser engraving, for example as a QR code, to be able to be scanned by an opening device 35 of the security institution and in particular a camera of a smartphone. Alternatively thereto, the lock identification code 33 may, for example, be readable via a radio connection, for example an RFID connection and in particular an NFC connection, wherein the identification device 31 may in particular have an active or a passive transponder for providing such a lock identification code 31. Thus, the luggage lock 11 generally enables an opening by various persons and in particular employees of a security institution if they have the opening code O without, however, having to provide a separate locking mechanism for the security institutions.

However, provision may be made to provide the owner with possibilities for checking whether or at what times an opening of the luggage lock 11 may take place by persons who have access to the database 38. As FIG. 7 shows, for this purpose, a master code M may in particular first be permanently stored in the memory 37 connected to the control device 29, wherein an initialization command A having an initialization code C and a device identification 49 of the opening device of the owner 35 may be received via the radio module 45, in particular in the course of a first coupling between the mobile opening device 35 of the owner and the electronic lock 11. The control device 29 may be configured to compare the initialization code C with the master code M and, in the event of a match, to store the device identification 49 as the owner identification 47 in the memory 37. The opening device of the owner 35 may hereby so-to-say be identified as a “trusted device” to the luggage lock 11 in order to grant this opening device 35 further authorizations with regard to settings of the luggage lock 11 and/or the actuation of the locking mechanism 15.

Provision may in particular be made that the control device 29 is configured, in a code change operation mode, to receive a code change command B, in particular via the radio module 45, from the opening device of the owner and to change the stored release code F in the memory 37 in response to the code change command B. For example, together with the code change command B, the device identification 49 may be transmitted again so that the code change command B may only be executed and the release code F may only be changed when the device identification 49 matches the owner identification 47 and the code change command B has therefore been transmitted by the authorized owner of the luggage lock 11 (cf. FIG. 7). For example, a changed release code F3 may be transmitted with the code change command B and the release code F stored in the memory 37 may be replaced with the changed release code F3.

Furthermore, it is illustrated in FIG. 7 that, in the memory 37, a first release code F1 may be stored that comprises a first release coding 53 and information about a release period Z, wherein a second release code F2 may furthermore be stored that only comprises a second release coding 55. The control device 29 may in particular be configured to change only the first release code F1, but not the second release code F2, in response to the code change command B. The control device 29 may further be configured to control the electromechanical locking mechanism 15 for a release of the locked securing section 23 if a transmitted opening code O comprises the second release coding 55 or if the transmitted opening code O comprises the first release coding 53 and was received during the release period Z.

Provision may in particular be made that the second release code F2 is only available to the owner, whereas the first release code F1 may be transmitted to the security institutions to selectively enable their employees to access the piece of luggage 13. In this regard, in the event of an opening attempt by a person other than the owner of the luggage lock 11, it may be checked whether this opening attempt takes place during a release period Z released by the owner and the securing section 23 may only be released in this case. Otherwise, the control of the electromechanical locking mechanism 15 may be omitted.

Such a distinction between the owner and other persons who have an opening code O may in particular also take place in that the device identification 49 is also transmitted in addition to the opening code O. The control device 29 may accordingly be configured to distinguish between an owner authorization and an authority authorization and, in the case that the device information 49 matches the owner identification 47, to control the electromechanical locking mechanism 15 to always release the securing section 23 when the opening code O is received; however, in the case that the device information 49 does not match the owner identification 47, to control the electromechanical locking mechanism to only release the securing section 23 if the corresponding opening command O was received during the release period Z. In such embodiments, only a release code F and information about a release period Z may therefore also be stored in the memory 37 of the luggage lock 11 so that the owner may selectively enable the opening of the luggage lock 11 by employees of a security institution for a certain time period—the release period Z—but may ensure that the luggage lock 11 cannot be opened by other persons outside the release period Z. To check whether an opening code O was received during the release period Z, the control device 29 is furthermore connected to a clock 59 of the electromechanical luggage lock 11.

In particular, in order to change the release code F, provision may be made that the release period Z and/or the release coding 53 is/are adapted by the code change command B. Furthermore, provision may be made that the release code F may be selectively activated or deactivated so that an owner of the luggage lock 11 may, for example before starting a journey or after handing over the piece of luggage 13 at a check-in counter, release an opening by employees of a security institution by activating the release code F in order, however, to be able to prevent the possibility of such opening again after the piece of luggage 13 has been received at the destination airport by deactivating the release code F. In this regard, a release period Z may ultimately be set indirectly by activating and deactivating the release code F.

Furthermore, information I may be stored in the memory 37 of the luggage lock 11 when an opening code O has been received at the code receiving device 43. In this regard, attempts to open the luggage lock 11 may be documented in the memory 37, for which purpose a point in time of the receiving of an opening code O, information about a location at which the opening code O was received, and/or the device information 49 of the mobile opening device 35 by which the opening code O was transmitted may in particular also be documented in the memory 37. It may furthermore be documented in the memory 37 when the sensor 61 detects a removal of the securing section 23 from the luggage lock 11 and the piece of luggage has thus actually been opened.

The radio module 45 may in particular form an interface 63 via which the memory 37 may be read so that an owner of the luggage lock 11 may track whether the piece of luggage 13 or the luggage lock 11 was, for example, opened by an employee of a security institution after the piece of luggage 13 was handed in at a check-in counter. The data or information included in the memory 37 may further be stored in encrypted form to prevent a reading of the memory 37 by unauthorized persons.

FIGS. 8A to 8C illustrate a method of providing an opening code O for a security institution to enable employees of the security institution to open a luggage lock 11 without destruction.

As FIG. 8A illustrates, in a step 95, in particular an owner of the luggage lock 11 may read the lock identification code 33 from the identification device 31 by the mobile opening device 35 before starting a journey and, in a step 97, may transmit the lock identification code 33 to the database 38 that may be read by the security institution (cf. also FIG. 8B). Furthermore, in a step 99, an opening code O may be transmitted to the database 38 so that a data pair of the lock identification code 33 and the opening code O may be stored in the database 38 to be able to be retrieved in the event of a check by an employee of the security institution. The lock identification code 33 and the opening code O may in particular be transmitted to the database 38 by the opening device of the owner 35 at the owner's command, wherein it is also possible to transmit the data pair of the lock identification code 33 and the opening code O to the database 38, for example via an internet website. Furthermore, the steps 97 and 99 may possibly also be performed by a manufacturer of the luggage lock 11 in that the data pair of the lock identification code 33 and the opening code O may be stored in the database 38 by the manufacturer to generally enable the security institution to open the manufactured luggage lock 11 without destruction.

FIG. 8C illustrates further steps that may in particular be taken by the owner of the luggage lock 11 to provide the opening code O for the security institutions. For example, in a step 101, provision may be made that the owner transmits a release period Z to the database 38 during which the luggage lock 11 may be opened by transmitting the opening code O. The owner may hereby ensure that the piece of luggage 13 may only be opened by employees of the security institution for the duration of a journey, whereas an opening by third parties may be ruled out after the journey has been completed or the piece of luggage 13 has been received and the release period Z has elapsed. As an alternative to transmitting a release period to the database, the owner may also simply activate the opening code O in the step 101. Furthermore, as already mentioned, the owner may also store the release period Z in the memory 37 of the luggage lock 11 so that the control device 29 of the luggage lock 11 may check the release period Z with recourse to the clock 59 of the luggage lock 11 and may prevent an opening of the luggage lock 11 outside the release period Z even on a manipulation of the database 38.

Furthermore, in a step 103, the owner may transmit information I about a travel route, for example an origin airport and destination airport, an airline, a flight number and/or any stopovers, to the database 38. This enables the security institution to trace via which travel route the piece of luggage 13 will be guided in order, for example, to assign an authorization for requesting the stored opening code O only to those employees who are stationed at the corresponding airports and may therefore perform a check, if necessary. However, such information I may also be transmitted to the database 38, for example, by an airline if its employees are, for example, allowed to read the lock identification code 33 and to transmit an associated flight number or travel route to the database 38 when checking in the piece of luggage 13.

Furthermore, in a step 105, the owner may possibly receive information about an elapse of the release period Z, whereupon the owner may, for example, extend the release period Z in a step 107. It may hereby be achieved that the owner may, for instance in the event of a delay in a journey, still extend the originally transmitted release period Z in order to nevertheless enable the security institutions to open the luggage lock 11 without destruction.

In a step 109, provision may furthermore be made to delete the opening code O or the associated release code F or F1 from the memory 37 of the luggage lock 11 and/or the database 38 after the release period Z has elapsed. In particular due to such a deletion, the owner may ensure that no access to the piece of luggage 13 by external persons and/or no manipulation of the database 38 is possible after the release period Z.

FIGS. 9A to 9C illustrate a method of opening the electronic luggage lock 11 by a security institution. In the step 95, the lock identification code 33 may again first be read from the identification device 31 by the mobile opening device 35 of an employee of the security institution and, in a step 111, said lock identification code 33 may be transmitted to the database 38 by the mobile opening device 35. Furthermore, the opening code O that is associated with the lock identification code 33 and stored in the database 38 may be requested. As a result of this request, in a step 113, the opening code O may be received at the opening device 35 from the database 38 and transmitted to the luggage lock 11 by the mobile opening device 35. The control device 29 of the luggage lock 11 may then compare the opening code O with the stored release code F and, if necessary, also consider a device identification 49 of the opening device 35 in order to release the securing section 23 in the event of a match of the transmitted opening code O with the release code F and/or in the event of a receiving of the opening code O within the stored release period Z and to enable the employee to access the piece of luggage 13 and check its contents.

FIG. 9C illustrates further steps that may be performed by the security institution after the lock identification code 33 and the opening code O for the electronic luggage lock 11 have been received in a step 115.

For example, in a step 117, information I about a travel route may be received that may, for example, comprise information about an origin airport and destination airport and/or one or more flight numbers. Depending on this information I, in a step 119, different opening devices 35 and/or different employees may be assigned a request authorization, wherein, for example, all the employees of the security institution who are stationed along the travel route may be assigned a request authorization for requesting the opening code O. Alternatively thereto, all the employees of the security institution may also be assigned such a request authorization.

If a request for the opening code O is then received in a step 121, this request may first be documented in the database in a step 123. For this purpose, information about the opening device 35 from which the request was sent, a point in time of the request, and/or a location from which the request was sent may be documented, for example.

Furthermore, in a step 125, it may be checked whether the request was received within a stored release period Z. If it is determined in a step 127 that the request was received outside the release period Z, the request for the opening code O may be rejected in a step 129. Alternatively thereto, a request to extend the release period Z may, however, also be transmitted to an owner of the piece of luggage 13 or his/her opening device 35 so that the owner may subsequently extend the release period Z, if necessary.

If, on the other hand, it is determined in a step 131 that the request was made within the release period Z, it may be checked in a step 133 whether a request authorization exists. This may, for example, take place by also transmitting a device identification 49 of the requesting opening device 35 in addition to the request for the opening code O so that it may be checked whether the opening device 35 or its user has been assigned a request authorization. If the request was made by an authorized employee of the security institution, the opening code O may be transmitted to the mobile opening device 35 in a step 135 so that the employee may open the electronic luggage lock 11.

If, on the other hand, no request authorization is present, the transmission of the opening code O may be rejected in a step 137. Thereupon, in a step 139, a request for a request authorization by the requesting employee may possibly be received so that an employee who was not originally assigned a request authorization may possibly nevertheless be enabled to check of the piece of luggage 13. As a result of this request, the opening code O may thus be transmitted to or a request authorization may be assigned to the employee in a step 141 or this request for the request authorization may also be rejected in a step 143.

Furthermore, in a final step 145, provision may be made to delete the stored opening code O from the database 38 after the release period Z has elapsed in order to guarantee that the opening code O cannot be retrieved from the database 38 at all after the release period Z has elapsed, not even in the event of a manipulation of the database 38 by unauthorized persons, and that the luggage lock 11 cannot possibly be opened by a person other than the owner.

Furthermore, a non-destructive opening of the luggage lock 11 by a security institution may alternatively be made possible by receiving a plurality of opening codes 35 and associated lock identification codes 33 of respective luggage locks 11 at the database 38 and storing the plurality of opening codes 35 and associated lock identification codes 33, or a selection thereof, on the mobile opening device 35 of the security institution. An employee of the security institution may then, in the course of a check, read a lock identification code 33 of the luggage lock 11 to be opened from its identification device 31 and retrieve the associated opening code O directly from the stored opening codes O in order to open the luggage lock 11 by transmitting the retrieved opening code O to the luggage lock 11 by the mobile opening device 35. In this regard, data pairs of lock identification codes 33 and associated opening codes O received at the database 38 may be transferred directly to mobile opening devices 35 of the security institution so that during a check, communication between an opening device 35 of an employee carrying out the check and the central database 38 does not necessarily have to take place, but the required opening code O has, for example, already been stored beforehand in a memory, not shown, of the opening device 35 and may be retrieved therefrom immediately after a lock identification code 33 has been read.

Thus, the luggage lock 11 described herein and the methods disclosed herein conveniently enable a piece of luggage 13 to be reliably protected against unauthorized opening attempts, but enable a security institution to open the luggage lock 11 without destruction in order to perform checks. Furthermore, the luggage lock 11 may be reliably secured against manipulations and possibilities for documenting opening attempts and/or opening processes may be provided to be able to trace the work of a security institution and/or, if necessary, to clarify and track unauthorized opening attempts.

### REFERENCE NUMERAL LIST

11 electronic luggage lock
13 piece of luggage
15 electromechanical locking mechanism
17 actuator
19 securing element
21 latch
23 securing section
25 luggage closure
26 zipper
27 handle of the zipper
29 control device
31 identification device
33 lock identification code
35 mobile opening device
37 memory
38 database
43 code receiving device
45 radio module
47 owner identification
49 device identification
53 first release coding
55 second release coding
57 mechanical locking mechanism
59 clock
61 sensor
63 interface
65 energy source
67 charging socket
69 button
71 fastening device
73 first container part
75 second container part
77 luggage body 78 hoop
79 inner space
80 lock body
81 lock environment
83 spring
85 slope
87 slope
89 slope
91 engagement opening
93 slope
82
95 reading the lock identification code
97 step
99 step
101 step
103 step
105 step
107 step
109 step
111 requesting the opening code
113 step
115 step
117 step
119 step
121 step
123 step
125 step
127 step
129 step
131 step
133 step
135 step
137 step
139 step
141 step
143 step
145 step
A initialization command
B code change command
C initialization code
E energy supply state signal
F release code
F1 first release code
F2 second release code
F3 changed release code
G closed position
H open position
I information
M master code
O opening code
R release position
S blocking position
T unlocking position
V locking position
Z release period This listing of claims will replace all prior versions, and listings, of claims in the application:
Listing of Claims:

1. An electronic luggage lock for securing a piece of luggage that can be opened by a security institution without destruction, said electronic luggage lock comprising an electromechanical locking mechanism by which a securing section of the piece of luggage can be selectively locked or released relative to the luggage lock, a control device for controlling the electromechanical locking mechanism, and an identification device,
wherein the identification device provides a lock identification code that is individually associated with the luggage lock and that can be wirelessly read by a mobile opening device, in particular a smartphone,
wherein the control device is connected to a memory in which a release code associated with the lock identification code is stored,
wherein the control device is further connected to a code receiving device that is configured to receive an opening code from the mobile opening device via a wireless connection, and
wherein the control device is configured to compare the received opening code with the stored release code and to control the electromechanical locking mechanism to release the securing section when the received opening code matches the stored release code.

2. (canceled)

3. (canceled)

4. The electronic luggage lock in accordance with claim 1, wherein the control device is configured, to change the release code stored in the memory in response to a code change command received from the opening device in a code change operation mode.

5. The electronic luggage lock in accordance with claim 4, wherein the control device is configured to distinguish between an owner authorization of the owner of the piece of luggage and an authority authorization of a security institution, and
wherein the control device is configured to only change the release code stored in the memory when the control device determines the owner authorization.

6. (canceled)

7. (canceled)

8. (canceled)

9. (canceled)

10. The electronic luggage lock in accordance with claim 4, wherein the release code comprises a release coding and information about a release period, and
wherein the control device is configured to control the electromechanical locking mechanism to release the locked securing section when the received opening code comprises the release coding and the opening code is received within the release period.

11. (canceled)

12. The electronic luggage lock in accordance with claim 10, wherein the control device is configured, in the code change operation mode, to change at least one of the release coding or the information about the release period.

13. The electronic luggage lock in accordance with claim 10, wherein the control device is configured to delete the release code from the memory after the release period has elapsed.

14. (canceled)

15. (canceled)

16. (canceled)

17. (canceled)

18. The electronic luggage lock in accordance with claim 1, wherein the control device is configured to document in the memory at least one of:
the receiving of the opening code in the memory;
a point in time at which the opening code was received;
information about the mobile opening device;
information about a location at which the opening code was received; or
a receiving of a detection signal that is transmitted from a sensor to the control device upon directly or indirectly detecting a movement of the securing section of the piece of luggage relative to the luggage lock.

19. (canceled)

20. (canceled)

21. (canceled)

22. (canceled)

23. The electronic luggage lock in accordance with claim 1, wherein at least one of:
the control device is configured to transmit an energy supply state signal to the opening device; or the luggage lock has a button by whose actuation the code receiving device can be activated to receive the opening code.

24. (canceled)

25. (canceled)

26. (canceled)

27. The electronic luggage lock in accordance with claim 1, wherein the electronic luggage lock is integrated into a piece of luggage that comprises a luggage body having a securing section, a first container part and a second container part movable relative to the first container part between an open position and a closed position,
wherein the second container part enables access to an inner space of the luggage body in the open position and blocks the access in the closed position, and
wherein the second container part can be secured in the closed position by locking the securing section.

28. (canceled)

29. A method of providing an opening code for a security institution for opening an electronic luggage lock comprising the steps:
transmitting a lock identification code of the luggage lock to a database, and
transmitting the associated opening code to the database.

30. (canceled)

31. (canceled)

32. (canceled)

33. (canceled)

34. (canceled)

35. (canceled)

36. The method in accordance with claim 29, wherein information about a release period during which the luggage lock can be opened by transmitting the opening code is transmitted to at least one of the luggage lock or the database.

37. (canceled)

38. (canceled)

39. (canceled)

40. The method in accordance with claim 29, wherein information about a travel route is transmitted to the database.

41. A method of opening an electronic luggage lock having a readable identification device by a security institution, comprising the steps:
reading a lock identification code of the luggage lock from the identification device,
transmitting the lock identification code of the luggage lock by a mobile opening device of the security institution to a database and requesting an associated opening code,
receiving the opening code from the database and transmitting the received opening code to the luggage lock by the mobile opening device.

42. (canceled)

43. The method in accordance with claim 41 comprising documenting in the database at least one of:
the request for the opening code;
a point in time of the request for the opening code;
a location of the request for the opening code;
a device identification of the mobile opening device; or
a person identification of a requesting user is/are documented in the database.

44. (canceled)

45. The method in accordance with claim 41, any wherein a request authorization is assigned to at least one of a plurality of mobile opening devices or persons, and wherein the opening code is only transmitted when the opening code is requested by at least one of an authorized person or an authorized device.

46. The method in accordance with claim 45, wherein the request authorization is assigned in dependence on information about a travel route of the piece of luggage, said information being stored in the database and being associated with the lock identification code.

47. (canceled)

48. The method in accordance with claim 41, wherein, after the identification device has been read, information about a point in time of a previous request for the opening code is displayed at the opening device.

49. The method in accordance with claim 41, wherein an opening of the luggage lock is enabled or effected by transmitting the received opening code to the luggage lock, wherein the opening is documented in a memory of the luggage lock.

50. The method in accordance with claim 41, wherein the opening code is only transmitted from the database to the mobile opening device when the request for the opening code is received during a release period stored in the database.

51. The method in accordance with claim 50, wherein, before the release period elapses, a request for extending the release period is transmitted from the database to a mobile opening device of an owner of the piece of luggage by which at least one of the lock identification code or the opening code has been provided.

52. (canceled)

53. (canceled)

54. (canceled)

55. (canceled)

56. (canceled)
